(19) United States
(12) Patent Application Publication
(10) Pub. No.: US 2010/0165407 A1
(43) Pub. Date: Jul. 1, 2010

(54) METHOD AND SYSTEM FOR PRINT AUTOMATION

(76) Inventors: Trish Witkowski, Dexter, MI (US); Mark Witkowski, Dexter, MI (US)

Correspondence Address: SCHWEGMAN, LUNDBERG & WOESSNER, P.A., P.O. BOX 2938, MINNEAPOLIS, MN, 55402, US

(21) Appl. No.: 12/604,244

(22) Filed: Oct. 22, 2009

Related U.S. Application Data
(63) Continuation-in-part of application No. 12/603,434, filed on Oct. 21, 2009.
(60) Provisional application No. 61/107,214, filed on Oct. 21, 2008.

(51) Int. Cl. G06K 15/00

(52) U.S. Cl. 358/1.18

(57) ABSTRACT

Systems and methods are described that provide print automation. In an example, a system and method dynamically create a page layout template comprising a compensation value. Other systems, methods, and apparatus are described.

### CLAIM OF PRIORITY

This patent application is a continuation-in-part of U.S. patent application Ser. No. 12/603,434, filed Oct. 21, 2009, which claims priority to U.S. Provisional Patent Application Ser. No. 61/107,214, filed Oct. 21, 2008, which applications are incorporated herein by reference.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

The invention relates generally to the field of printing and graphic design, and more specifically to methods and systems to automate printing production.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic diagram illustrating a workflow;

FIG. 2 is a control flow diagram illustrating a method of constructing a template;

FIG. 3 is a block diagram illustrating a machine in the example form of a computer system, within which a set or sequence of instructions for causing the machine to perform any one of the methodologies discussed herein may be executed, according to various embodiments;

FIG. 4 is a schematic diagram illustrating a workflow;

FIG. 5A is a graphic of a design-to-finishing workflow;

FIG. 5B is a graphic of an enhanced design-to-finishing workflow;

FIGS. 6-11 are screen shots illustrating implementations of user interfaces;

FIG. 12 is a graphic illustrating multiple files;

FIGS. 13 and 14 are screen shots illustrating implementations of user interfaces;

FIG. 15 is a chart illustrating vertical markets and product scope;

FIGS. 16A-D are examples of a user interface to manage PDF documents;

FIGS. 17A-E are examples of a user interface to animate a folded piece;

FIG. 18 is a screen shot of a menu system;

FIG. 19 is a screen shot of a folding template manager;

FIG. 20 is a screen shot of a folding template manager;

FIG. 21 is a dialog box for compensation preferences;

FIG. 22 is an example user interface of a cut sheet tab;

FIG. 23 is an example user interface of an envelope tab;

FIG. 24 is example user interface of a library tab; and

FIG. 25 is an example of a template.

### DETAILED DESCRIPTION

The following works are incorporated herein by reference, in their entirety: “A Field Guide to Folding,” by Trish Witkowski, ISBN 978-0-9791796-8-6; “MIS, A Guide for Managers,” by Network PDF, LLC, ISBN 978-0-9791796-6-2; and “JDF, A Guide for Managers,” by Network PDF, LLC, ISBN 978-0-9791796-1-7.

Computer integrated manufacturing (CIM) is used to describe a partially or fully-automated manufacturing process. When the automation extends beyond the manufacturer, for example to billing, suppliers, or buyers, then the process is referred to as integrated automation (IA). Either CIM or IA can be used to implement more efficient systems. In some industries, CIM and IA are indistinguishable and can be used interchangeably.

In the printing industry CIM, either alone or in conjunction with IA, can be used to automate and streamline print jobs from the creative designer to the warehouse and shipping facilities. As pre-press and printing services become more computerized, and therefore more programmable, automation naturally follows. One aspect of printing automation that has continued to be difficult to automate is folding.

Print folding comprises both mechanical and manual folding of paper, or other printing materials, to provide a creative and economical printed presentation. There are many different types of folds, including but not limited to, accordion folds, gate folds, map folds, and roll folds. When designing a print layout, the designer should be aware of fold placement so that they can adjust their art to accommodate the crease in the paper. Fold placement is important, especially in the common scenarios of heavy ink coverage and color breaks that are intended to fall directly at the fold.

In an example, a template generator is used to prepare a page template with appropriate margins, gutters, and page markings to allow designers to design, create, and manage content on a print layout for an intended folding style. The page template can include parameters, such as folding style, number of folds, page orientation, paper size, paper weight, target printing apparatus, and the like. These parameters can be encapsulated in a message format to be communicated from the creative designer to the pre-press to the printer and elsewhere. By computing the folding compensation on the front-end, such as by using a template generator, and then providing the measurements and other variables to other portions of a printing and manufacturing process, fewer errors are encountered during the process, which results in savings of time and money.

This document includes an overview of a system to provide integration with components of a printing and manufacturing system. The document also provides a detailed description of each component in an example printing and manufacturing system.

### Overview

### The FOLDRite™ System

The FOLDRite™ System was documented in 2002 when the book FOLD: The Professional's Guide to Folding was published. Based on years of industry research, and winner of the GATF InterTech™ Technology Award in 2004, the FOLDRite™ System is truly unique to the graphic arts industry and fills a niche in the market. FOLDRite™ addresses the longstanding print production problem of folding compensation and standardizes the folding process for consistent and predictable results—which leads to process automation and other production efficiencies.

The FOLDRite™ System comprises:
Naming/numbering conventions: Folding styles in the FOLDRite™ system can be identified by a name and number. Folding styles are first classified into one of eight folding families—accordions, basics, exotics, gates, maps, parallels, posters, and rolls—based upon certain distinctive characteristics. Once classified into a folding family, a folding style is given an identifying name and number, either of which can be used independently when referring to the specific folding style.
Folding compensation processes: Industry-approved folding compensation processes for folding styles ensure predictable results and consistency from the design phase of the job to the finishing stages. The processes can be utilized in many ways, such as integration into software for template creation, JDF, and programmable folding machinery.
Folding compensation refers to adjusting certain panels of a folded piece to be made slightly smaller to accommodate for the dimensionality of the paper and for standard process variation in the print finishing process. The mathematics of this process can vary greatly based upon the weight of the sheet—the thicker the sheet, the greater the compensation,—and on the number of sheets of thickness, which can cause “pushout” as layers of paper are compressed together.
Folding illustrations: Illustrations to show folding sequence, and Flash animated folding illustrations to demonstrate the fold to the user.
Levels: classifies a folding style as a level 1, 2, 3 or S (specialty) and guides the user to folding styles that suit their budget and resources.
Production notes: The System also includes comprehensive technical considerations for an individual folding style. From warnings regarding paper weight and scoring, to budgetary, auto-insertion and postal regulation concerns, the production issues are addressed.

### FOLDRite™ Product Offerings:

FOLDRite™ Template Master—An Adobe® InDesign® Plug-In which is purchased as a plug-in application and run inside the page layout software Adobe®® InDesign. Template Master builds instant custom folding templates that are production-ready. The Template Master user-interface can be customized for OEM applications, and modifications and parameters/preferences can be tailored to suit the needs and specifications of individual companies. This software can also be configured to accommodate other page layout software packages.
Foldfactory.com—An Adobe®® InDesign® Server-based web product that allows a user to create and purchase FOLDRite™ templates online and download them to their computer. Foldfactory uses a community format, with forums, blogs, and other useful resources for the graphic arts industry.
Both of the above applications have a core set of eleven folding styles. These eleven styles can then be modified to create 80+ distinct variations of these folding styles.
A Field Guide to Folding and FOLD: The Professional's Guide to Folding—publications that document the System and contain other useful folding educational information.
Folding for the Graphic Arts: A Teacher's Handbook—curriculum supplement that teaches graphic arts educators how to teach about folding.
Anatomy of a Fold—informational poster.
Other FOLDRite™ innovations in development are a FOLDRite™ template export to Flash, which allows capability to animate layout in 3-D and watch it fold; direct mail tools; Template Master customization; and Book Builder book cover template creator.

### About the FOLDRite™-Generated Template:

FOLDRite™ Template Master and foldfactory.com builds two page templates—side A and side B—of the folded piece. The template is initiated with three layers. These layers organize the fold marks and panel cues that are visible in the slug area, and the fold guides that sit on the page. Both of these layers can be viewed and hidden. The layers are locked to avoid accidental movement of these markers. The third layer is the live art layer, where page layout is to begin.

The folding compensation processes can be applied to any software application, such as Adobe® ® InDesign®.

### How the Technology of FOLDRite™ Works:

Plugin: Using a RealBasic software application, the user interacts with the user who enters one or more parameters of their custom folding templatee.g., style, style modifications, flat/finished size. The user then can choose either to save the information as a preset, or to build the template. If they choose to build it, the software communicates folding parameters to the InDesign® plug-in, and using JavaScripting, the InDesign® application commands are given. These commands control the InDesign® application to build a folding template to the specified parameters in real-time.

foldfactory.com: Using a Java Web interface, the user interacts with the web site to enter one or more parameters of their custom folding template—style, style modifications, flat/finished size. The information about the fold is then stored in an XML archive for future use. When a user decides to build and download a template, a fee is assessed to the user and a PHP script initiates a SOAP request to InDesign® Server. Once the request is received, an AppleScript® is called and the commands control InDesign® Server to build the folding template to the specified parameters in real-time. At this point, the user is given permission to download the InDesign® template to their local computer for 24 hours.

Web-to-Print: Using a Web-to-Print digital storefront (or offered as software as a service (SaaS)), a user can visit the “store” and choose a folding style. In this Software as a Service model, the user can be given the option to design their layout online with an InDesign® Server-based application. The online InDesign® (or another creative application) document would be built to proper size and format, using FOLDRite™ measurements. The user can then choose to view their layout as a folding animation. Once the animation is viewed and the user is content with their project, the user can decide to send the file to print, setting in motion a digital print and production process. In the background, the FOLDRite™ template can communicate with the MIS system and digital print equipment through JDF and XMP data to transfer fold and trim instructions to the finishing equipment for lights-out automation.

### Example Systems and Methods

### Example System

The example printing and manufacturing system includes the following components:
A) A design platform
B) A pre-press operation
C) A printing operation and
D) A finishing operation

### Design Platform

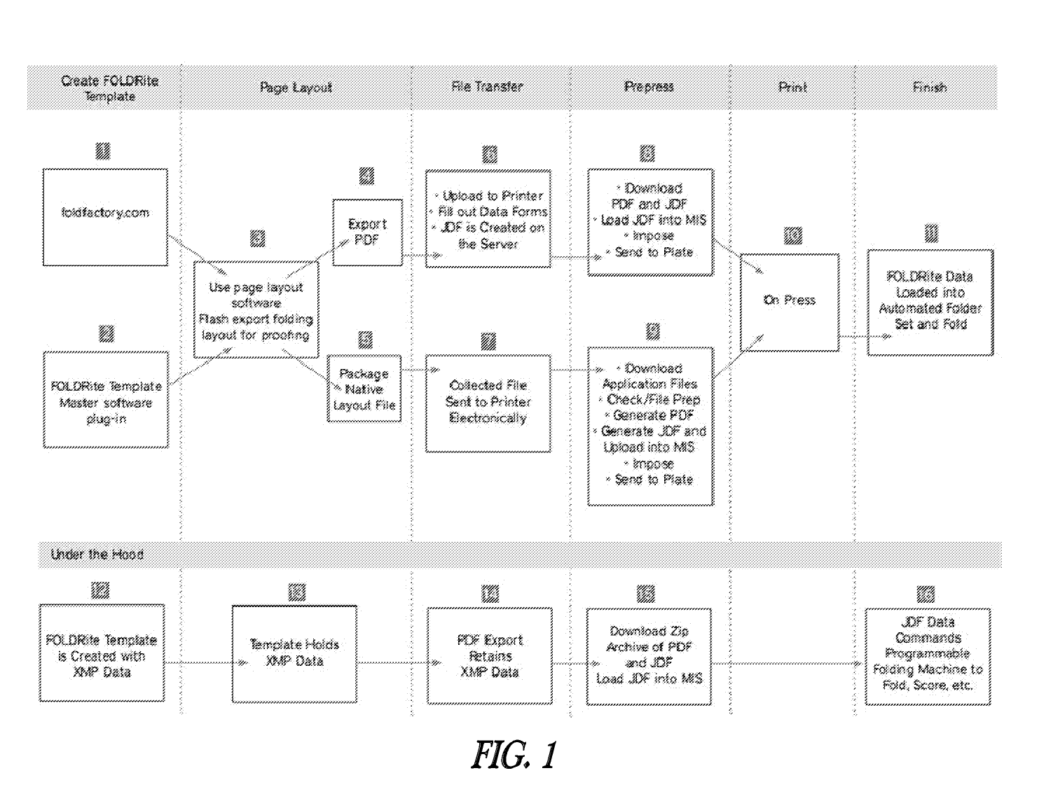

Referring to FIG. 1, a designer can use the design platform to create, design, and manage content in a page layout for printing. To assist the designer, the designer can visit an online repository of folding layout templates (1), such as those provided at www.foldfactory.com, to build a press-ready folding template prior to creating the layout. The designer can create a custom template based upon their specifications, such as folding style, page orientation, paper size, and the like, or they can choose to create a template from a library of saved presets. Alternatively, the designer can access the folding layout templates using a client software package (2), such as a software plug-in, which allows access to folding templates through a page layout software, such as Adobe® ® InDesign®. The plug-in can exist as a consumer product or can be distributed as a custom OEM version from a vendor with customized settings, presets, and constraints.

In an example, a FOLDRite™ folding template is generated after the user chooses the folding style, modifies the folding style based on their preferences, and enters dimensional parameters by either finished dimension or flat sheet size. Using the entered data, the system utilizes a specific process that multiplies entered dimension and panel count and takes compensation and sheet thickness into consideration to calculate the fold guide and fold mark placement, and to place panel cues in the slug area for the final page layout template.

Although the examples are illustrated using the FOLDRite™ Template Master plug-in and www.foldfactory.com online system with Adobe® ® InDesign® page layout software, it will be appreciated that any software package, online or stand-alone, can be used to perform the functions described herein.

After a template is downloaded or built within the software, the template is ready-to-use with fold marks and guides locked in place and panel cues in the slug area. The designer can then use their page layout software to create the designed layout (3). The designer/user has the option to export the folding layout as a Flash animation for proofing purposes. After the design and proofing, the designer can export their page layout as a single electronic file, such as a portable document format (PDF) file, to send the file electronically (4) or the designer can collect the native file, fonts, and links and transfer the file electronically to the print vendor (5)(7).

Should the designer decide to export the file electronically as a PDF file (4), then the file is communicated to a pre-press operation. For example, the designer can access a web portal to upload the PDF and to fill out additional data fields (6). The additional data fields can be collected and arranged in a structure format document. In an example, the document is formatted using extensible markup language (XML). In an example, Adobe® ® Extensible Metadata Platform (XMP) is used to embed the additional data fields (e.g., metadata). In an example, the collected XMP content will ultimately be translated to a Job Definition Format (JDF) file, which can be created by the server after uploading the XMP data tags. In an example, the server translates XMP data tags to JDF tags to create a Job Messaging Format (JMF) message file.

To capture and retain the settings, the templates are created with hidden extensible metadata platform (XMP) tags that hold job data related to folding intent, folding style, folding compensation and placement, and trim size (12). At (3) additional information can be captured using XMP data tags and appended to the existing tags. The XMP data tags stay with the file whether it is in native format or exported as a PDF (13) (14).

### Pre-Press Operation

Continuing with reference to FIG. 1, when the page layout is provided in a PDF document, the printer can access the document, such as by accessing the web portal to download the PDF file. In addition, one or more JDF files, which were created by the server (e.g., web portal), can be downloaded. In an example, tools are built into software that notifies the prepress department if the FOLDRite™ fold marks or guides have been moved by the designer. JDF is loaded into a centralized management system, such as a Management Information System (MIS). The management system can process and impose the PDF file and then send the imposed PDF to plate (8).

Alternatively, when the page layout file is provided as a collection of files, fonts, and links (5)(7), then the printer receives the collected native page layout file by electronic transmission (e.g., e-mail, FTP, etc.). The file is opened and checked, and then prepped for print. A PDF is generated and the prepress department uses a JDF-builder tool to create the JDF. In an example, the JDF-builder tool is an online service where a printer uploads the PDF and the XML tags are extracted from the PDF to form the JDF file. The JDF is uploaded to MIS, where similar to (8), the PDF is processed and imposed and then sent to plate (9).

To implement this workflow, in an example, the web portal can create a compressed archive, such as a Zip archive, of PDF and JDF together for download. The archive can include client-input information and hidden XMP data related to the FOLDRite™ template. FOLDRite™ processes are licensed for integration within the MIS System; therefore, JDF can be loaded directly into the management system (e.g., MIS) (15).

### Printing Operation

Continuing with reference to FIG. 1, at (10), the printing job goes to press on the designated device, such as offset printing, digital printing, or web press. The management system (e.g., MIS) can use the JDF/JMF to manage the print job.

### Finishing Operation

Continuing with reference to FIG. 1, at (11), FOLDRite™ data is loaded into a folder to set and fold the print output. In an example, FOLDRite™ processes used to calculate margins and folding compensation are licensed for integration within automated folding machinery. The folding machinery understands the folding intent from the JDF/JMF and is capable of automatically folding the printed piece. Depending upon the needs of the vendor, additional finishing process data can be added to enhance a FOLDRite™ JDF file, such as trimming, scoring, slitting, die cut, etc.

The JDF file drives the finishing equipment to automate the folding process, completing the fully automated design-to-finishing workflow (16).

### Another Example Design System

FIG. 4 is a schematic diagram illustrating the workflow for a design system.

Template creation: moves proper file production upstream to document initiation.

1. A user (e.g., designer) can visit www.foldfactory.com and create a custom FOLDRite template based upon their desired specifications.

### Or

2. A user who owns a legal copy of the software plug-in, can access to FOLDRite through page layout software. The plug-in can exist as a consumer product, or is distributed as a custom OEM version from a vendor with customized settings, presets, and constraints.

### Or

3. A user can visit a Web-to-Print “storefront” and choose a folding style.
18. Under the Hood: The FOLDRite templates are created with hidden XMP tags that hold job data related to folding intent, folding style, folding compensation and placement, and trim size.

### Page Layout: Blank, Production-Ready Template is Provided, Simply Start Designing

4. Once the template is built, an animation can be generated as a visual representation of the content on the page and the exact configuration of the folding style.
5. After template is downloaded, or built within the software, it is ready-to-use with fold marks and guides locked in place and panel cues in the slug area. A user can use page layout software to create the designed layout.

### Or

6. Web-to-Print Workflow: In a web-to-print scenario, the template is not downloaded, rather it is used online in a Software as a Service (SaaS)configuration. The user can use the page layout software through a Web browser to create a layout on the template.
7. PDF workflow: the user can export their layout as a PDF to send the file electronically

### Or

8., 10. Traditional workflow: the user can collect the file, fonts and links and transfer the file electronically to the print vendor.

### Or

11. Web-to-Print Workflow: The user can finish the layout and view an animation to approve. The user can then activate the “Print” button to set the automated print production process into motion.
19., 20. Under the Hood: The XMP data tags stay with the file whether it is in native format, or exported as a PDF

### File Transfer Smart File Carries Information for JDF Creation

9. PDF workflow: a user can access a web portal to upload the PDF, and to fill out additional data fields that will add to the collected XMP content that will ultimately be translated to a JDF file, which can be created on the server.

### Prepress: Streamlining the Process

12. PDF workflow: A printer can access the web portal to download the PDF and JDF files. In an example, tools that are built into the software notify the prepress department if the FOLDRite fold marks or guides have been moved. JDF is loaded into the MIS system. PDF file is processed and imposed, sent to plate.

### Or

13. Traditional workflow: A printer can receive a collected native page layout file by electronic transmission (e-mail, FTP, etc.), the file can be opened and checked, and prepped for print. A PDF can be generated, where a prepress department can use a software tool to create the JDF. The JDF is uploaded to MIS, where the PDF is processed and imposed, then sent to plate.

### Or

14. Web-to-Print Workflow: The file can be automatically sent through MIS system and into prepress, extracting necessary XMP and JDF data.
21. Under the Hood: A web portal can enable creation of Zip archive of PDF and JDF data together for download, carrying client-input information, and hidden XMP data from the FOLDRite template. FOLDRite algorithms are licensed for integration within MIS System. JDF loads directly into MIS system.

### Print: Standard Procedure

15. PDF workflow or traditional workflow: A job can go to press on the designated device, such as offset printing, digital printing, web press.

### Or

16. Web-to-Print Workflow: A file is printed digitally.

### Finish: FOLDRite is the Key to Total Process Automation

17. PDF workflow or traditional workflow: FOLDRite algorithms are licensed for integration within automated folding machinery. The machine understands the folding intent from the JDF and automatically folds the printed piece. Depending upon the needs of the vendor, additional finishing processes may be added to enhance a FOLDRite JDF file, such as trimming, scoring, slitting, die cut, etc.
22. Under the Hood: JDF file drives the finishing equipment to automate the folding process, completing the fully automated design-to-finishing workflow.

### Example Methods

Several functional modules can be determined and constructed to work together to calculate a folding template. In addition, these modules can provide the measurements in a parameterized form to other components of a printing or manufacturing system (e.g., a printer or a folding device). Some or all of these functional modules can be executed at a server. The modules can also be executed at a client (e.g., through the use of a plug-in software module).

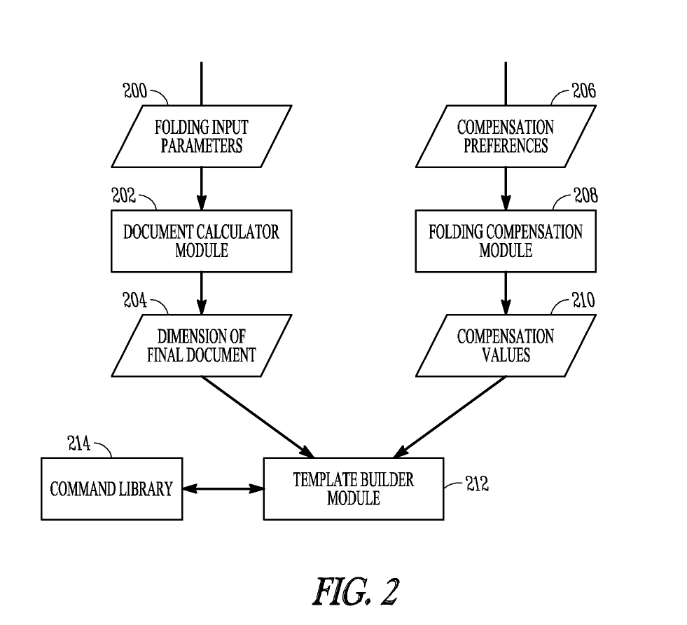

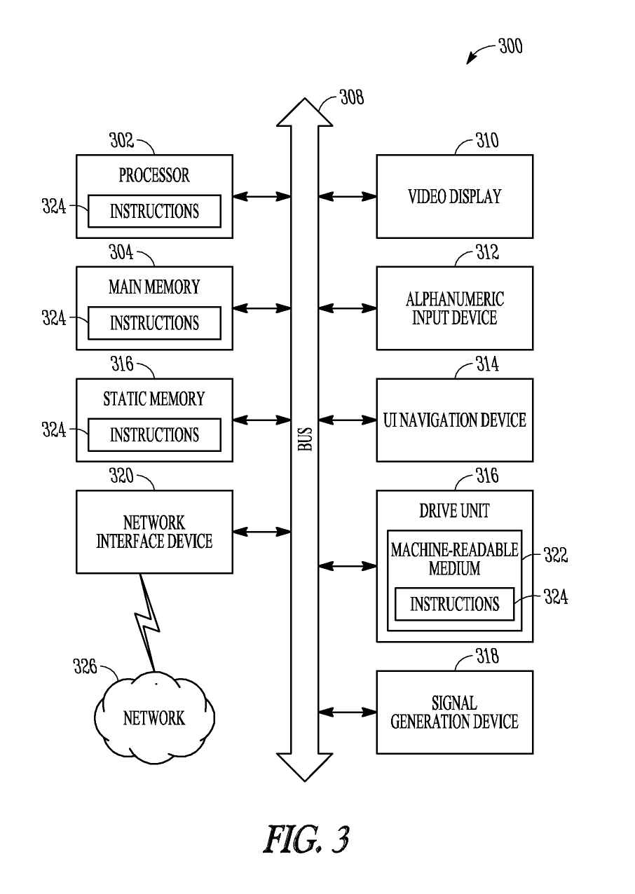

Referring to FIG. 2, one or more folding input parameters 200 are provided to a document calculator module 202. The folding parameters 200 can include inputs such as a folding style, panel characteristics or specifications, or other user preferences related to the layout or presentation of the finished document. Various folding styles are described in “A Field Guide to Folding” attached herein as Appendix A. The document calculator module 202 determines the dimensions of the final document 204, which compensates for the panel size, margins, folding compensation values, and other preferences. Depending on the type of fold used, the folding compensation values can be calculated differently. For example, when a roll fold is used, the folding compensation value can be aggregated to accommodate for the cumulative compensation encountered in a roll fold.

One or more compensation preferences 206 are provided to a folding compensation module 208 to calculate the folding compensation based on the compensation preferences 206. Examples of compensation preferences 206 can include document measurement units (e.g., inches, millimeters, points, or centimeters), an increased weight of compensation (e.g., an over-compensation value), or a compensation index. The compensation index can be used by the folding compensation module 208 to access a set of compensation values from a table, in an example. The folding compensation module 208 provides the compensation values 210.

The dimensions of the final document 204 and the compensation values 210 are then used by the template builder module 212 to create a template for use in a graphics design software package. In an example, the template builder module 212 creates an InDesign® file with the parameters of the finished height and width. The template builder module 212 can create a customized layer in the InDesign® file to maintain the template guides and marks separate from other data in the file. In an example, the template builder module 212 can revise, update, or otherwise modify an existing InDesign® document to include an additional layer with the template information. The template builder module 212 can resize the existing document accordingly to accommodate for the compensation values.

The template builder module 212 can communicate with a command library 214 to interface with the page layout software package. For example, the command library 214 can be configured as an application programming interface (API) with one or more fundamental operations to build and manage elements in a file format, e.g., elements in an InDesign® document layer. The template builder module 212 can be specific to a particular folding style or folding family, such that a plurality of template builder modules 212 are selectively executed based on the folding input parameters 200. In such a configuration, the use of an API, such as the command library 214, promotes good software design (e.g., reusability).

In an example, the template builder module 212 can be adapted or configured to provide an envelope or cut-sheet page template.

### Example Hardware

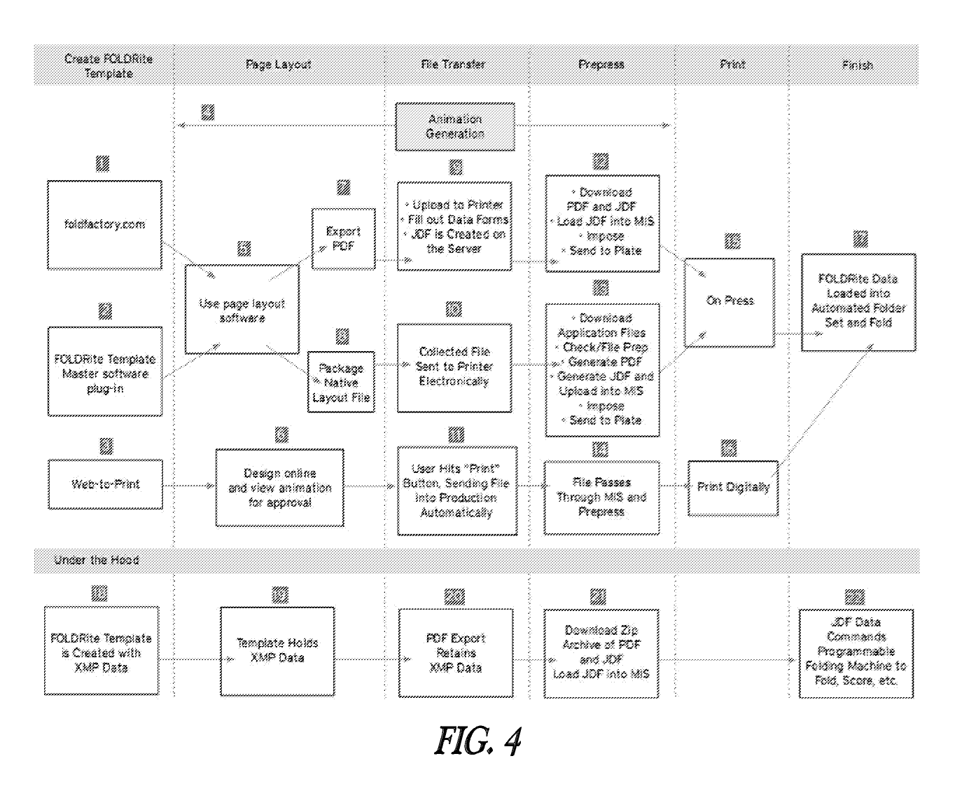

FIG. 3 shows a diagrammatic representation of machine in the example form of a computer system 300 within which a set of instructions, for causing the machine to perform any one or more of the methodologies discussed herein, can be executed. In alternative embodiments, the machine operates as a standalone device or can be connected (e.g., networked) to other machines. In a networked deployment, the machine can operate in the capacity of a server or a client machine in server-client network environment, or as a peer machine in a peer-to-peer (or distributed) network environment. The machine can be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g., a central processing unit (CPU) a graphics processing unit (GPU) or both), a main memory 304 and a static memory 306, which communicate with each other via a bus 308. The computer system 300 can further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 can also reside, completely or at least partially, within the main memory 304 and/or within the processor 302 during execution thereof by the computer system 300, the main memory 304 and the processor 302 also constituting machine-readable media.

The software 324 can further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, and optical and magnetic media.

Although the present inventive subject matter has been described with reference to specific example embodiments, it will be evident that various modifications and changes can be made to these embodiments without departing from the broader spirit and scope of the inventive subject matter. Accordingly, the specification and drawings are to be regarded in an illustrative rather than a restrictive sense.

### FOLDRite: Overview

Paper is dimensional, and if it is to fold into itself to form a brochure, the panels that fold should be slightly smaller due to the thickness of the sheet and the standard process variations in folding production.

This adjustment is called “folding compensation” and for lack of tools, education materials, and resources on the topic, the adjustment has been done manually by prepress departments. FOLDRite™ automatically calculates folding compensation, allowing for production-perfect folding and a standardized process.

### Core Component:

The core component of FOLDRite™ is the industry-approved folding compensation processes that allow for the creation of production-perfect folding templates. These processes, also referred to herein as mechanisms, use various characteristics of the folding project to calculate the folding compensation values.

### Other Components of FOLDRite™:

Other FOLDRite™ components include Flash animated folding illustrations for folding styles, standardized naming conventions, and production notes for folding styles. In addition, the components can provide a system to specify the level of difficulty for budgetary guidance.

### What Problems Does FOLDRite™ Solve:

### Industry Problem:

Lack of a standardized file submission format for folded material has created a longstanding print production roadblock that prohibits automation. Also, there is no way for internal personnel or external clients to visualize and simulate the folding proof.

### FOLDRite™ Solution:

Standardized file submission through dynamic template creation streamlines the process for automation, increases communication and efficiencies. Flash animated folding layouts allow for better visualization and soft proofing.

### Industry Problem:

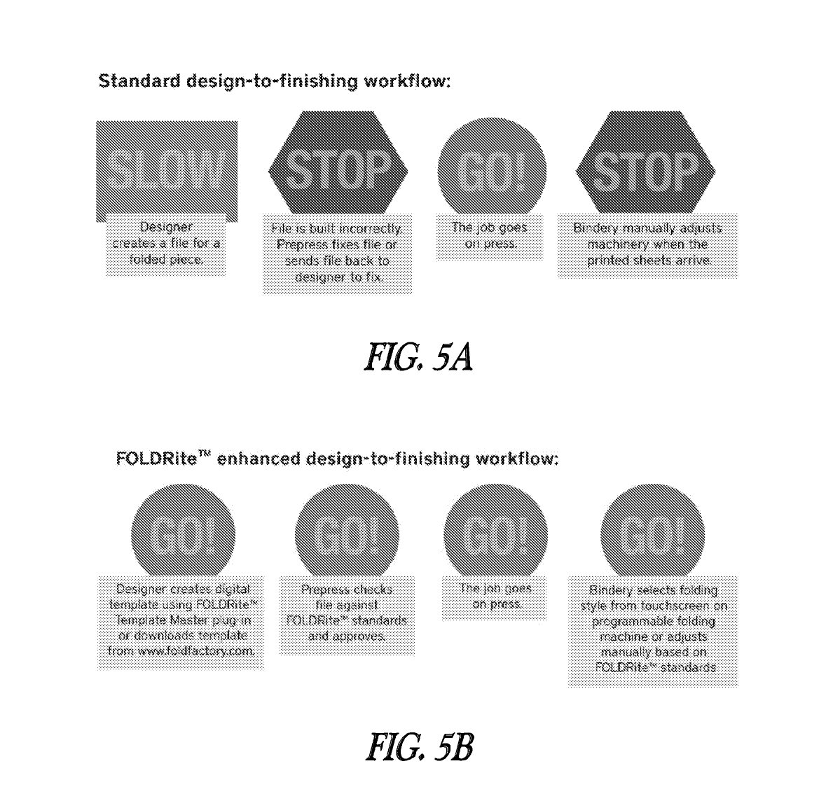

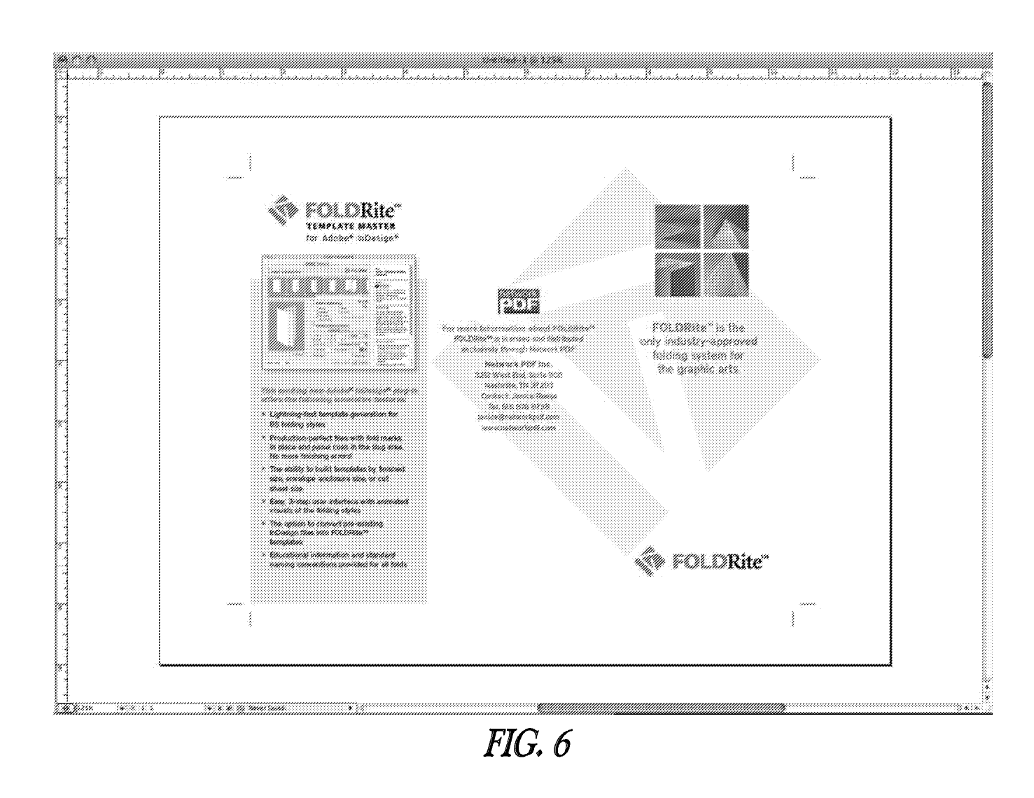

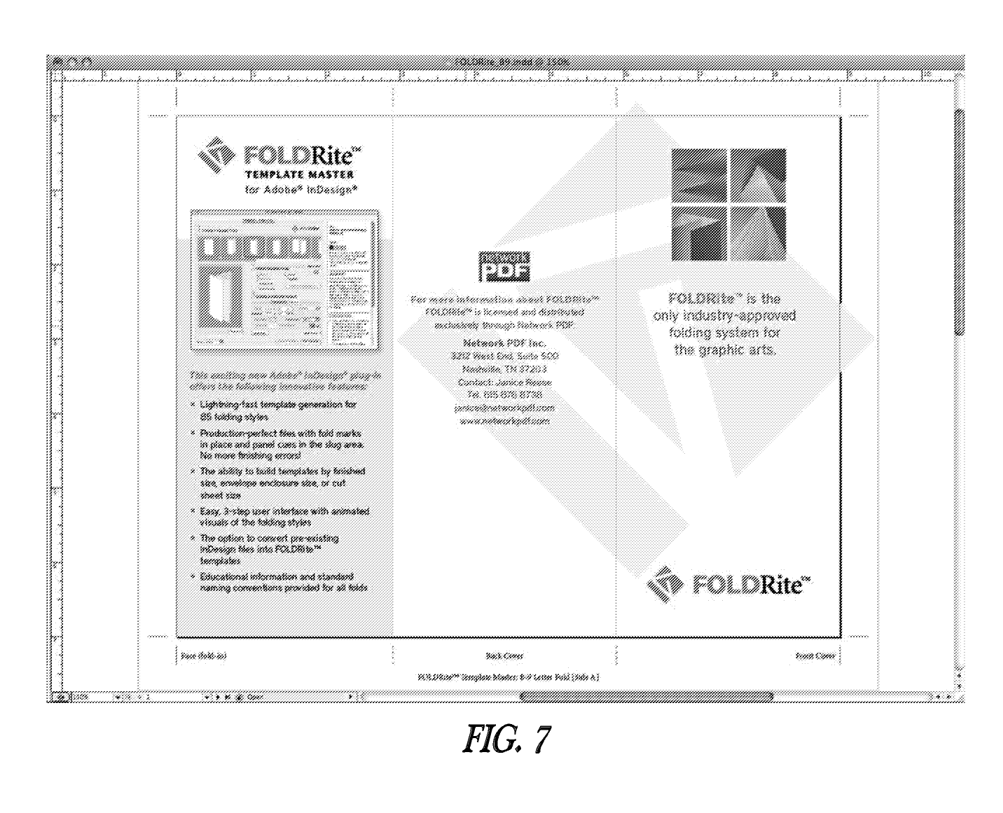

With reference to FIG. 5A, automation of the creation of templates for book covers has been difficult because the spine is produced in bulk. As such, the spine measurement is often an unknown entity or a moving target until the book is in final production and stock and page count is confirmed. Prepress resizes file and adjusts art manually, which prohibits process automation and contributes to longer production time.

### FOLDRite™ Solution:

With reference to FIG. 5B, automated spine bulk calculator uses processes to determine spine bulk and create a production-ready cover file. “Update” feature allows for spine adjustment on the fly.

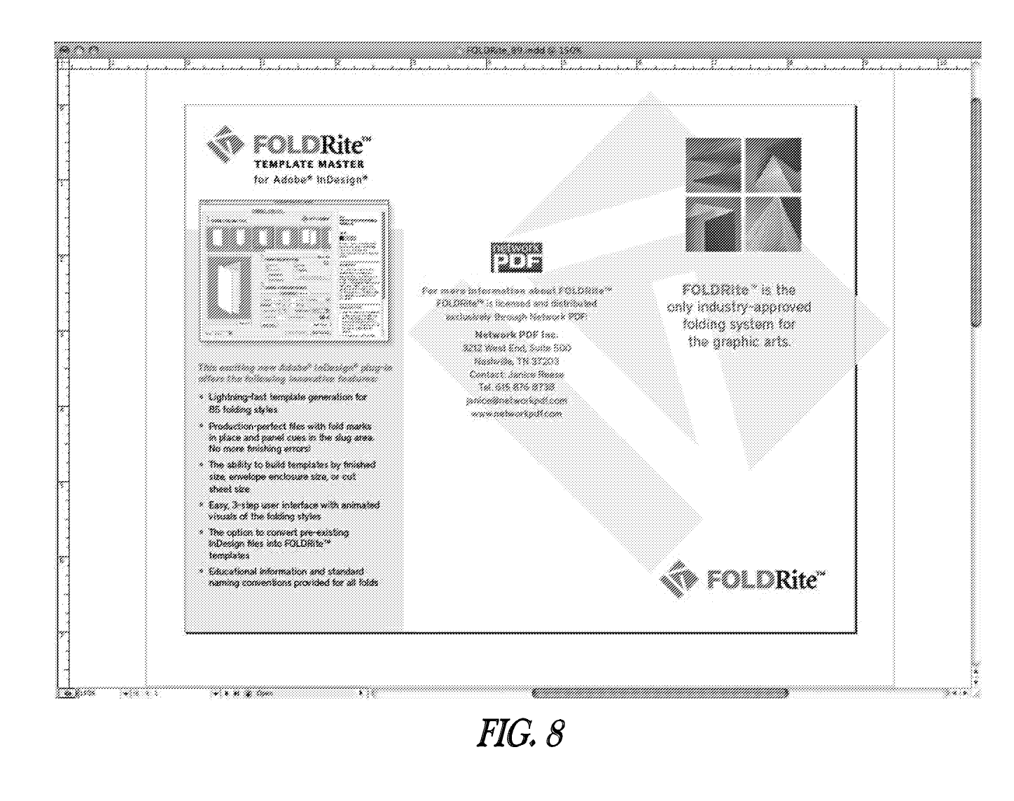

Industry example #1: With reference to FIG. 6, designer “floats” document on a larger sheet with crop marks.

Common Fix: Push back to designer with detailed instructions or reconstruct file in prepress and send PDF for approval before running proofs.

FOLDRite™ solution: With reference to FIG. 7, proper file setup is to trim size. FOLDRite™ creates template that is compensated for the folding process and built to trim size.

Industry example #2: With reference to FIG. 8, designer does not compensate for the folding process or use fold marks. Printer unsure of folding style and hesitant to move artwork.

Common fix: Call designer to confirm folding style and adjust for folding compensation in prepress.

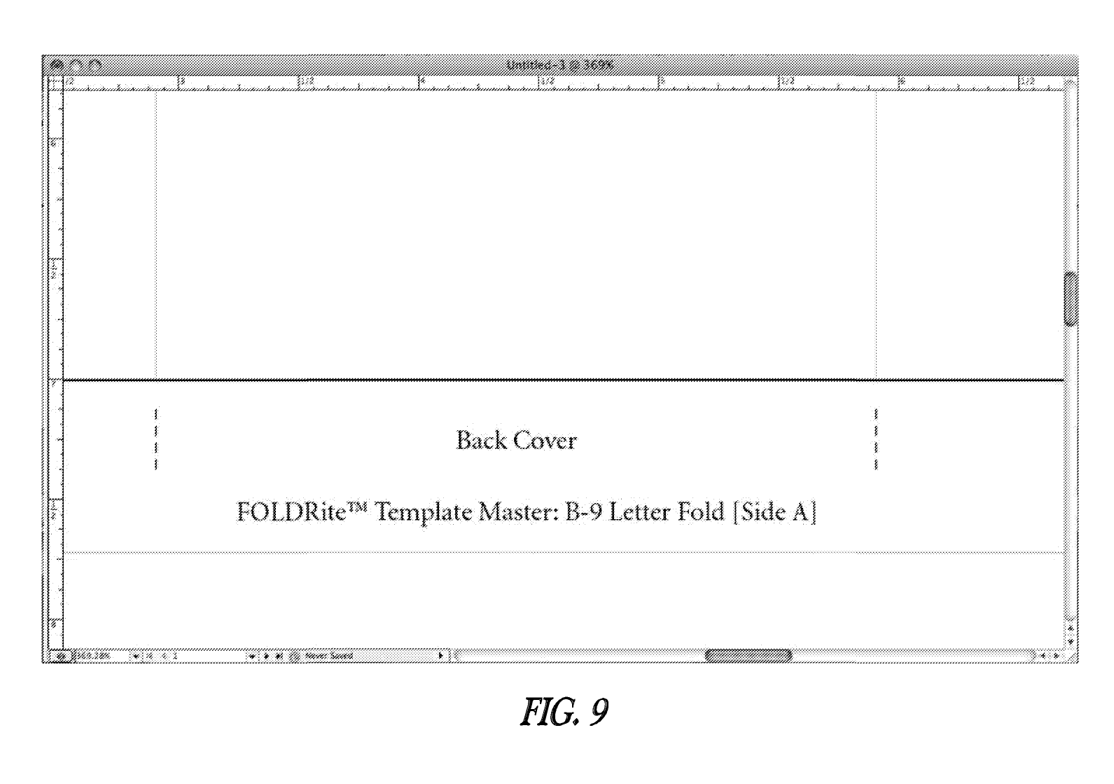

FOLDRite™ solution: With reference to FIG. 9, template is automatically compensated for the folding process, fold marks are in place and locked in layers, and folding style is indicated in slug area.

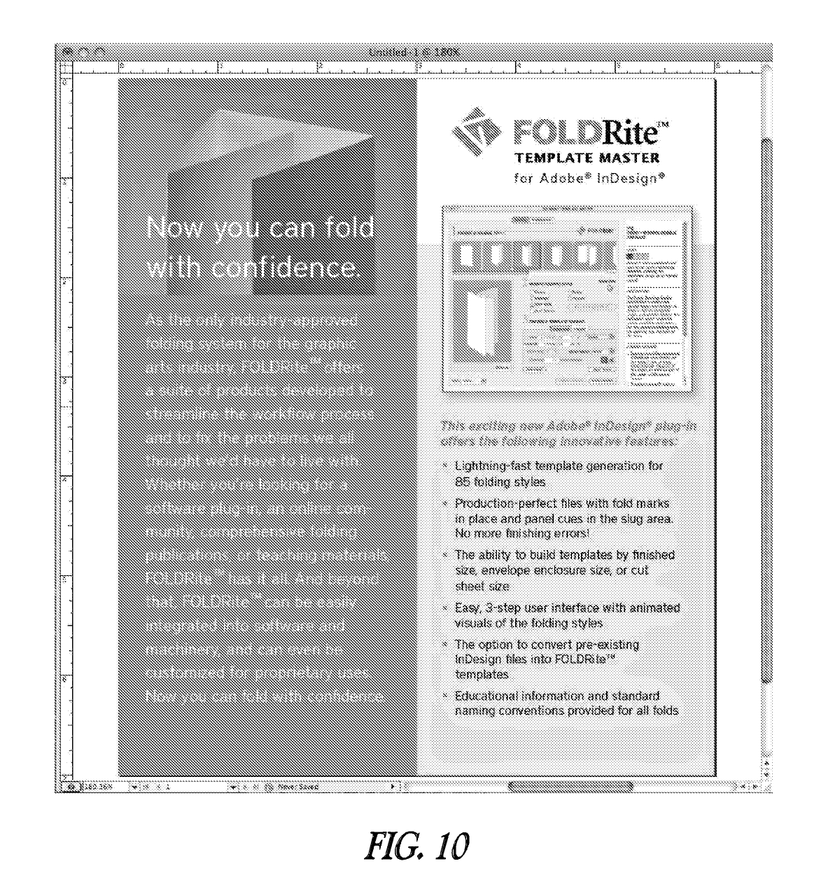

Industry example #3: With reference to FIG. 10, designer submits file in reader spreads.

Common fix: Push back to designer with detailed instructions or reconstruct file in prepress and send PDF for approval before running proofs.

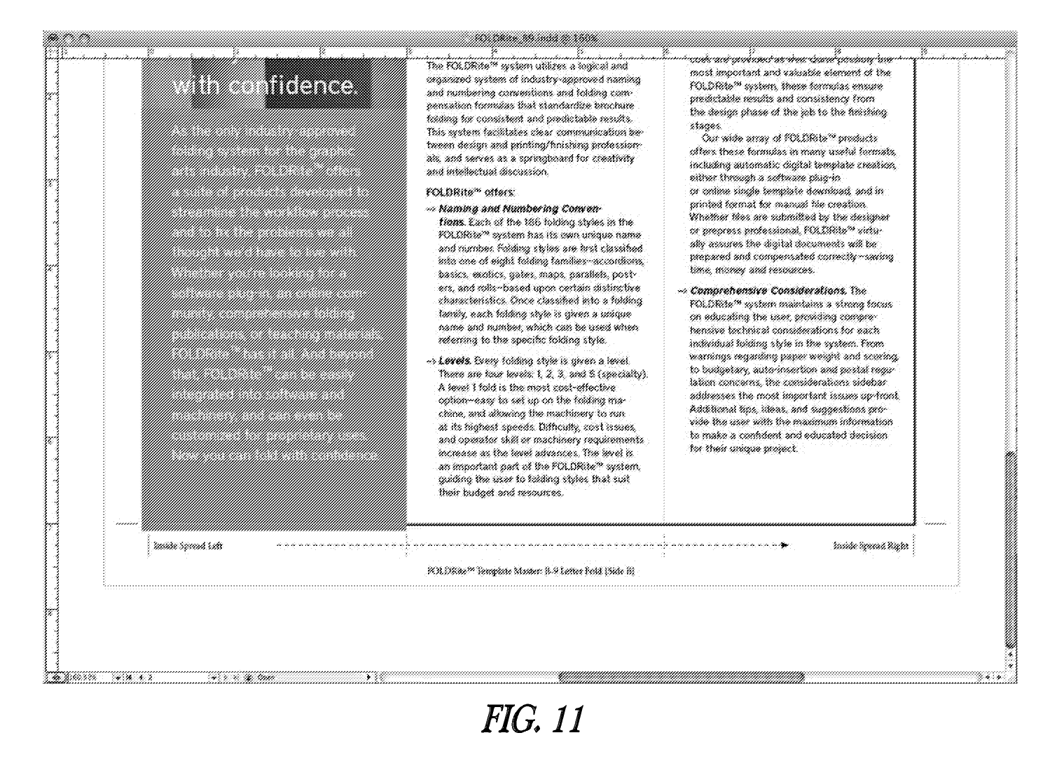

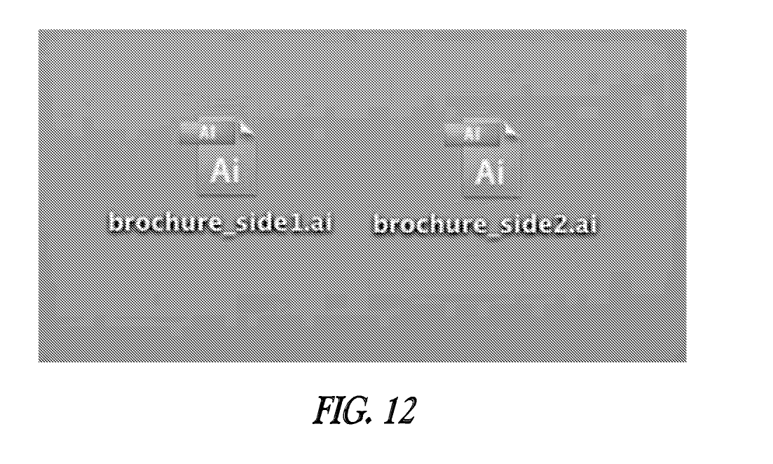

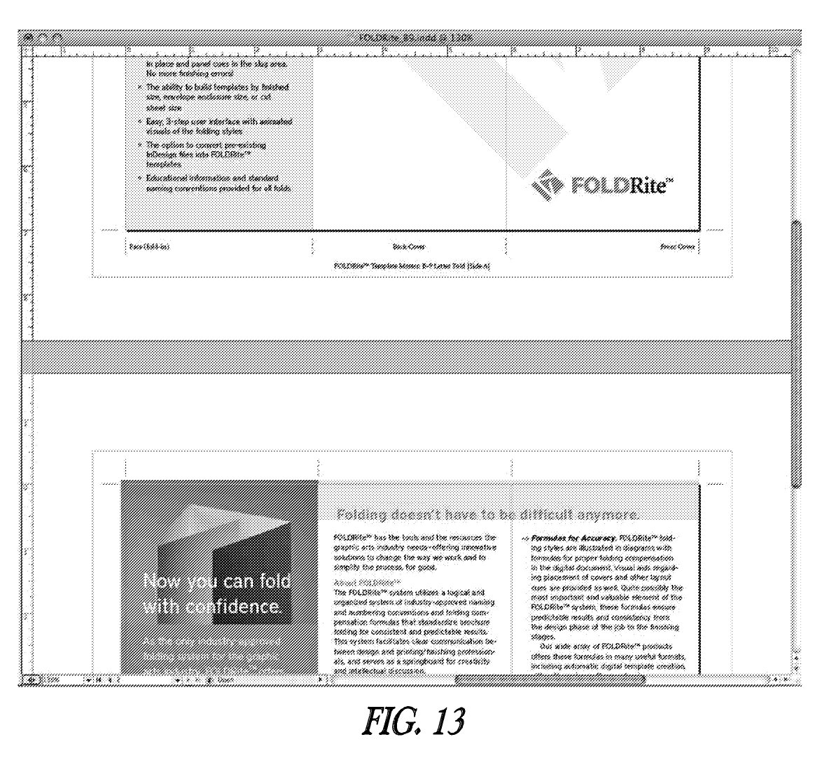

FOLDRite™ solution: With reference to FIG. 11, Proper file setup is in printer spreads. Panel cues in slug area give designer the ability to better visualize folded piece as flat layout.

Industry example #4: With reference to FIG. 12, designer submits file as two, single page Illustrator files (side one and side two).

Common fix: Push back to designer with detailed instructions or reconstruct file as 2-page InDesign® file in prepress.

FOLDRite™ solution: With reference to FIG. 13, proper file setup is a 2-page document. FOLDRite™ builds a ready-to-use 2-page InDesign® file.

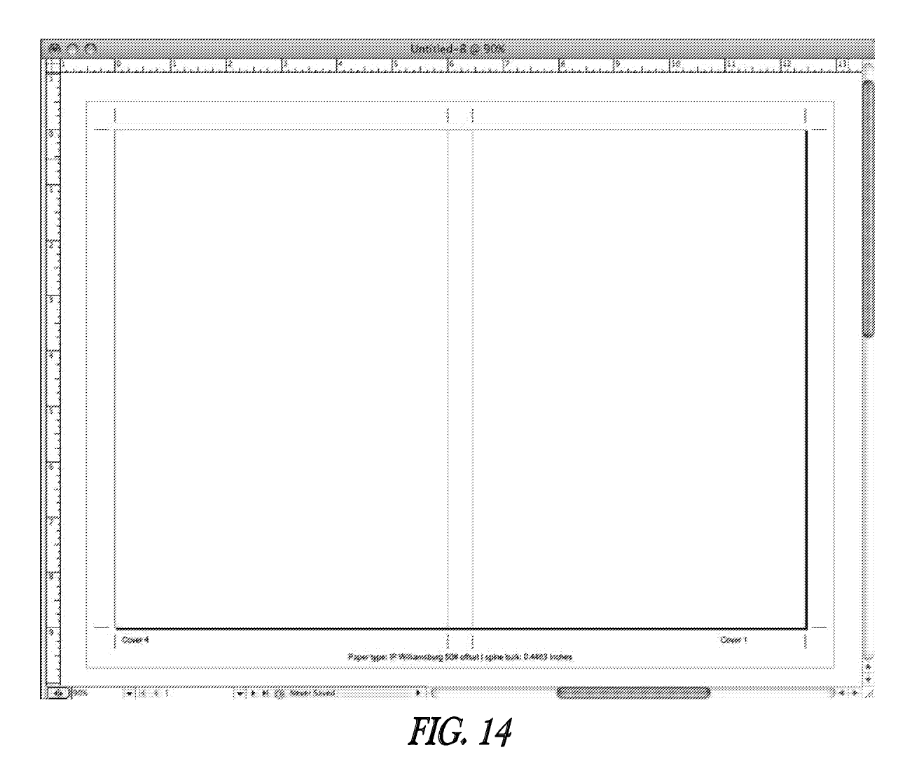

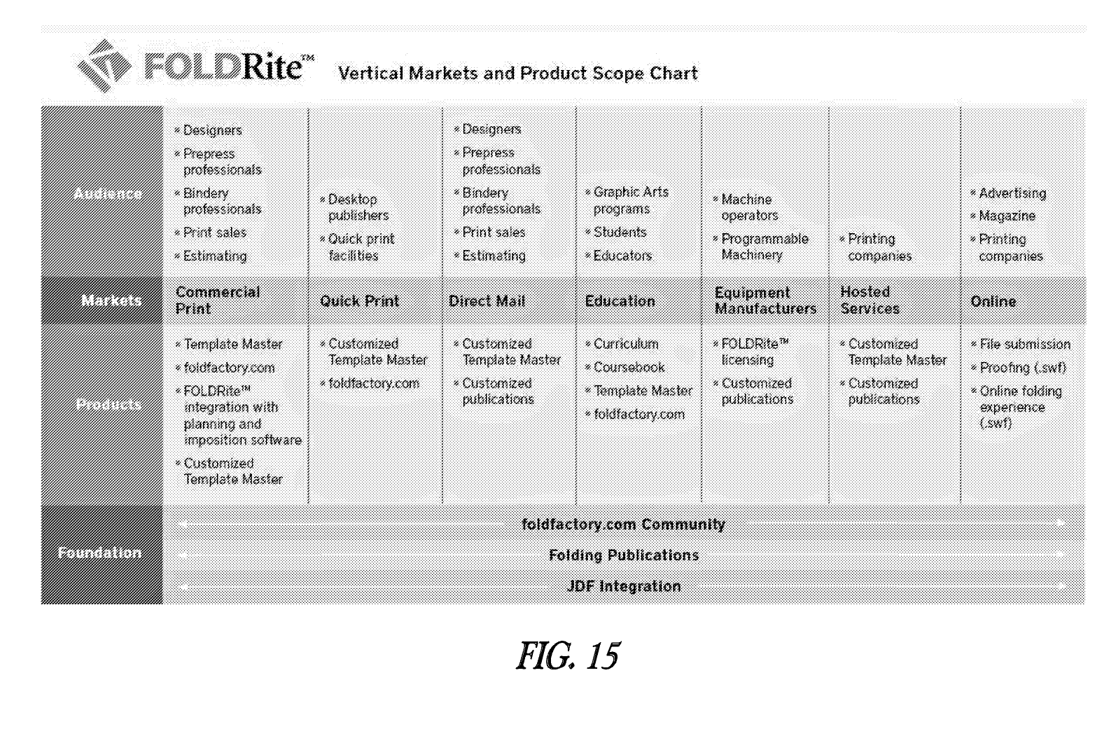

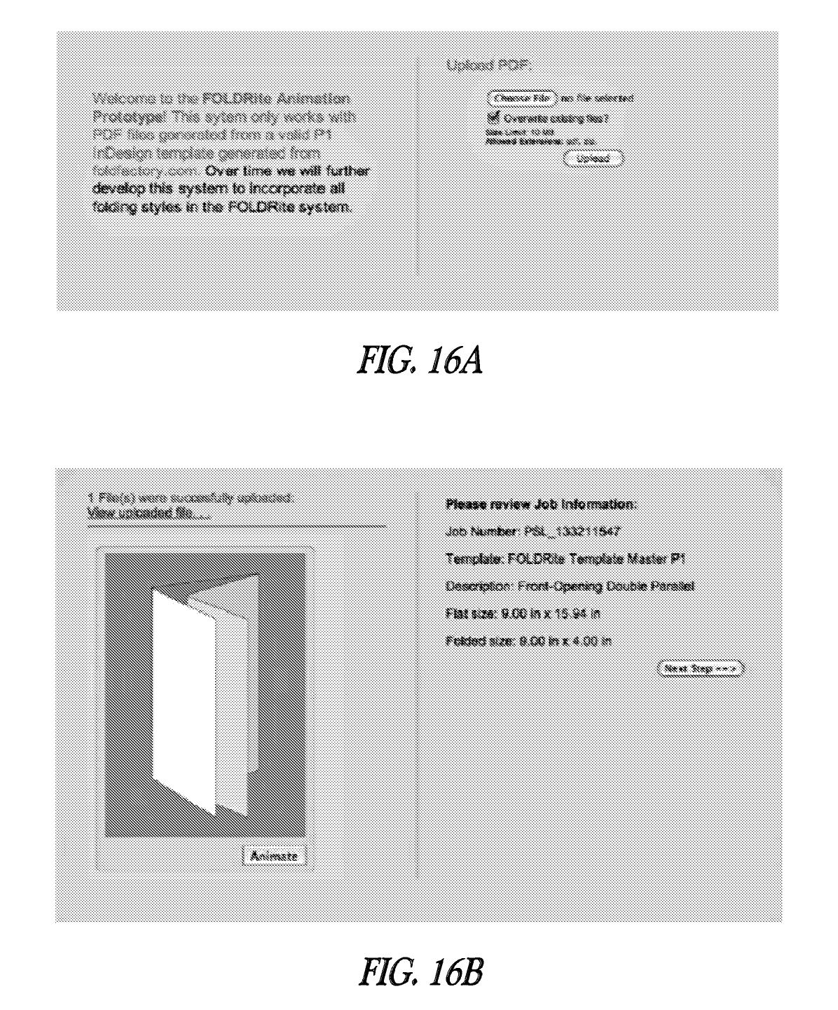

With reference to FIG. 14, FOLDRite™ book cover template is built as a 2-page document (C1-C4). Fold marks indicate spine, and descriptor in slug area indicates stock choice and spine bulk measurement.

### Additional FOLDRite™ Features:

Flash exported folding illustrations direct from InDesign® animate layout as folded product, also serves as proofing system. This is discussed in greater detail below under the heading “Animated Templates”.

SaaS (Software as a Service)

Flex and Air integration

JDF integration

Web-to-Print online services

Integration with programmable folding machines for end-to-end automation

Additional version of Template Master to include postal regulations, direct mail and book

### Advantages of Using FOLDRite™ Templates:

Move proper file setup upstream to the designer at document initiation
Eliminate margin for error with automated process
Sustainable process for design and production
Standardize the process for predictable results
Ability to automate production workflow and save time and money
Improve communication between printers and designers
Dynamic, custom product that is unique to the industry gives the user flexibility, accuracy and variety.
   FOLDRite™ is a Modular System that Can be Applied to the Following Markets:
Commercial Print
Digital Print
Direct Mail
Quick Print
Education
Finishing Equipment Manufacturers
Hosted Services
Online Web to Print
Book/Magazine/Catalog

### Animated Templates

1. In an example, a server-based tool can convert a supplied PDF file into a Flash animation of the folding style. A Web-based upload service and a Web delivery interface can be used for animation viewing. The system may be referred to as the trade name FOLD-n-MOTION.
2. The FOLD-n-MOTION system is a server product that can accept a 2-page PDF file and convert it into a Flash animation of a specific FOLDRite folding style. In a workflow, the supplied PDF files will have been created with Template Master or via foldfactory.com. In another workflow a user interface can be provided to have the folding parameters entered manually (or picked up from an XML job ticket).
3. Software and workflows can be installed on a customer purchased and hosted server. Proper error trapping, queuing and auto recovery code can be provided to ensure reliable performance.
4. One use of FOLD-n-MOTION is for proofing workflows. In these workflows, the following features can be provided:
   a. Comments and annotations for collaborative approvals
   b. Transparency for the ‘sides’ with a slider to show backup of the page
   c. Rulers and guides that can be dropped onto the page and used
   d. Digital signature that approves the proof
5. Other uses for the system can be centered around a parallel ‘online’ version of the printed brochure. Features can be variable data (via PURL's).
6. Additionally:
   a. The system can be hosted on the customer servers at their location or a centrally hosted system
   b. PDF to animation for all 86 FOLDRite folding styles, or for additional folding styles for a custom folding configuration requested by a client.
   c. Other systems can be used to get specifications to be used in the workflow.
7. Example workflow
   a. Printed matter is designed and a PDF is created
      i. Fold-n-Motion users can generate a PDF from a layout document. In an example, this document can be created in InDesign. XMP tags can be used for validation or the user can be relied on to prepare the document properly and check to make sure that folding compensations are accounted for in the files.
   b. A trigger will kick off the conversion of the PDF to an animated folding Flash file
      i. The specifications for the FOLDRite folding style intended for use are gathered. Possible workflows include:
         1. SOAP service published by the FOLD-n-MOTION system where parameters are accepted via a computer to computer interchange of parameters.
         2. JDF ticket supplied to a hot folder or submitted via JMF, the ticket can contain all of the specifications for the fold animation.
         3. A series of hot folders, one for each fold are published and a PDF is dropped in the appropriate folder. Whatever is dropped is processed to a standard size.
         4. Specs built into each PDF via XMP tags. As another example, build an XMP tag editor style sheet and have the user manually fill in the information in Acrobat or InDesign or another application that will add the metadata into the PDF file based on a user interface.
         5. Web-based job ticket and upload system to capture specs and kick off the workflow. This method can use either the SOAP system or the XML job ticket system to capture the job specifications and submit them to the system.
         6. Direct export of the PDF from InDesign using the Template Master plug-in
   c. The prepared PDF files can be accessed by the converting system
      i. Examples of methods to access the PDF files include:
         1. File path included in the SOAP call or JDF ticket
         2. PDF into a hot folder
         3. PDF uploaded from the Web form
   d. The 2-page PDF file can be converted to a series of images.
      i. These images can be further sliced based on the needs of the animation engine.
   e. Generate the Flash animation
      i. This can be implemented using one or more animation libraries
   f. Notification and Delivery
      i. Methods include, but are not limited to:
         1. Email delivery to the printer that all is completed
         2. Return command from the SOAP service
         3. Placing the completed job in another hot folder
         4. Web returns form and file pickup facility

### Example Implementation of Flash Conversion

### Upload Portal

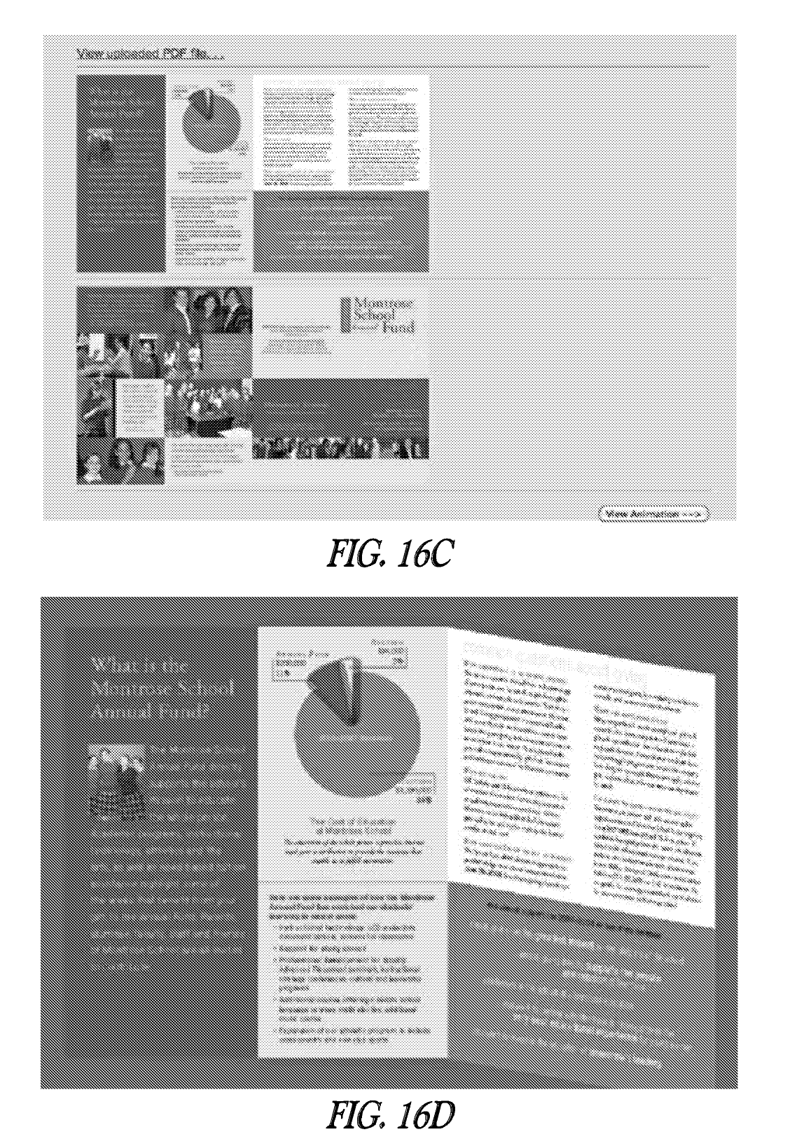

When the user enters the Web site, they can upload a PDF file into the system (See FIG. 16A).

### XMP Processing

With reference to FIG. 16B, first, the system parses the uploaded PDF file to locate the XMP tags. Once the data is located, it is stored as hidden form tags and the relevant information is presented to the user.

All XMP data can be stored using the point measurement unit. FOLDRite specific XMP tags include:

dc:creator

dc:subject

dc:title

dc:description

xmpRights:WebStatement

xmp:foldrite_panelwidth

xmp:foldrite_panelheight

xmp:foldrite_panelcount

xmp:foldrite_docunits

xmp:foldrite_exposedarea

xmp:foldrite_ID

xmp:foldrite_template_ID

xmp:foldrite_description

xmp:foldrite_compensation1

xmp:foldrite_compensation2

xmp:foldrite_compensation3

### Image Conversion

With reference to FIG. 16C, when the user clicks the ‘Next Step’ button, in an example, the server creates a series of images. Whole page images as well as sliced ‘panels’ are generated as needed for the folding animation.

The user can be presented with the front and back images as well as a link to view the uploaded PDF file.

### Animation Generation

With reference to FIG. 16D, when the user clicks ‘Next Step’ the system assembles the sliced images in the proper sequence and generates the SWF and presents it to the user.

### Example Implementation of Flash Animation

### General Display

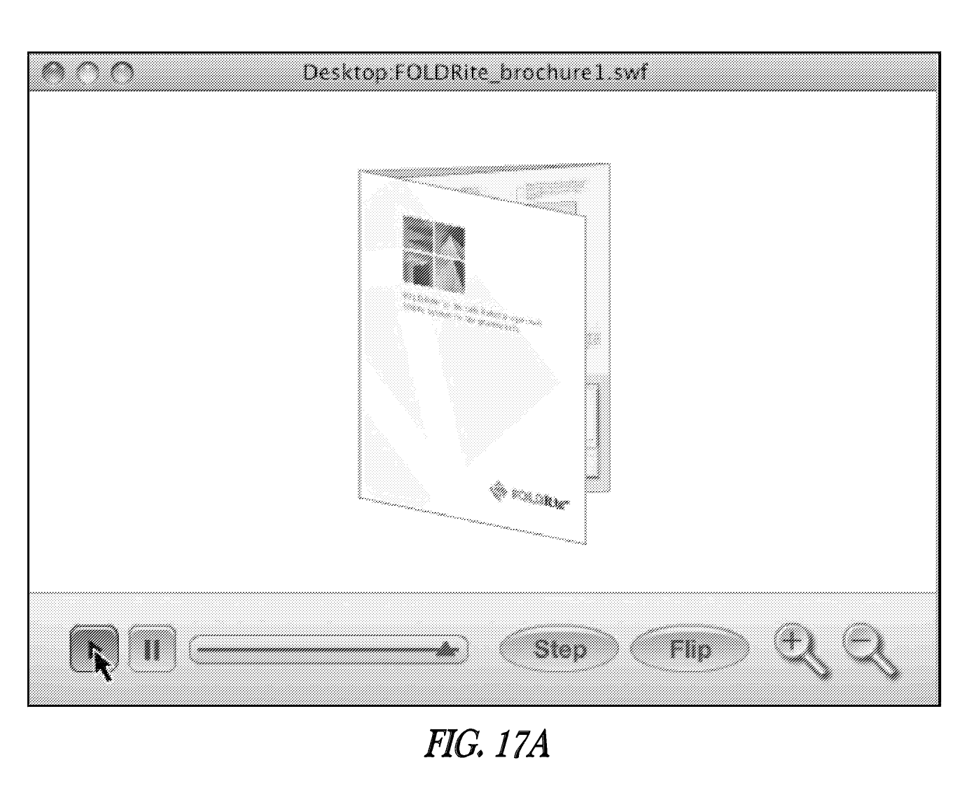

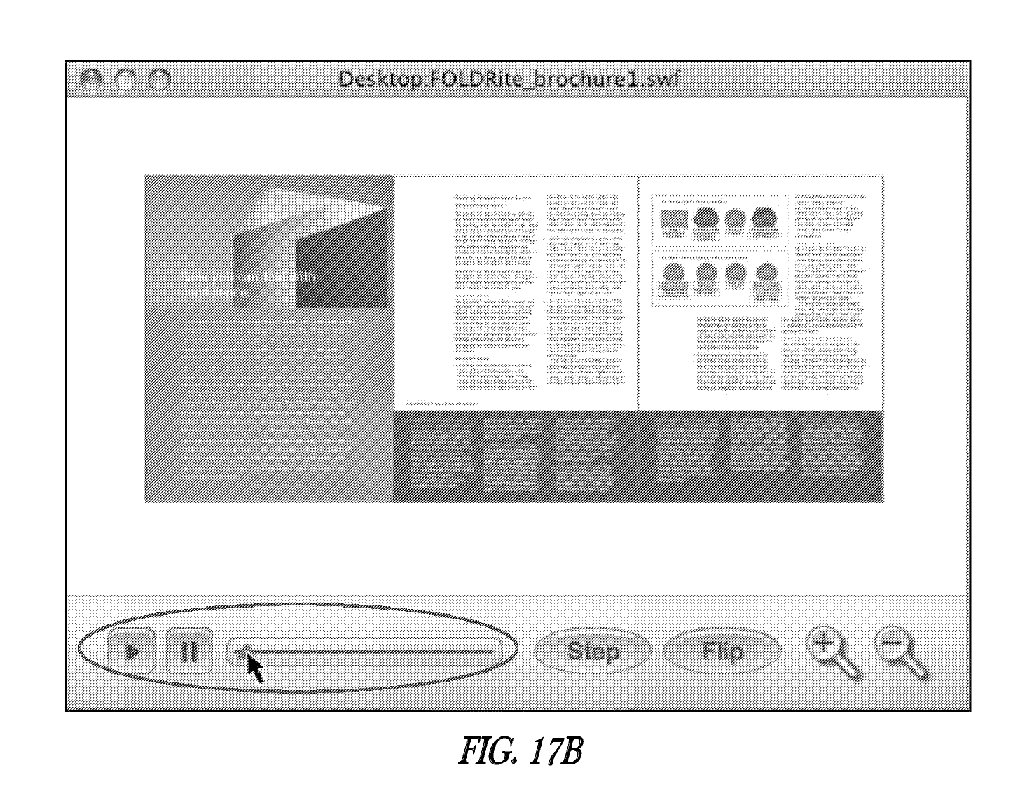

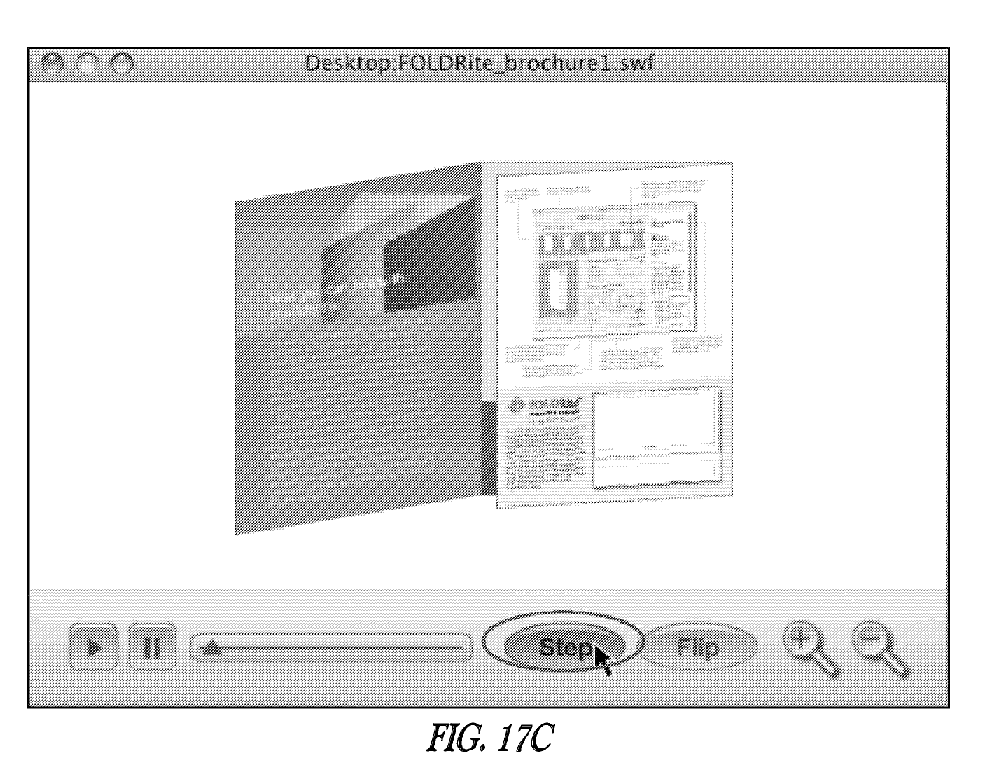

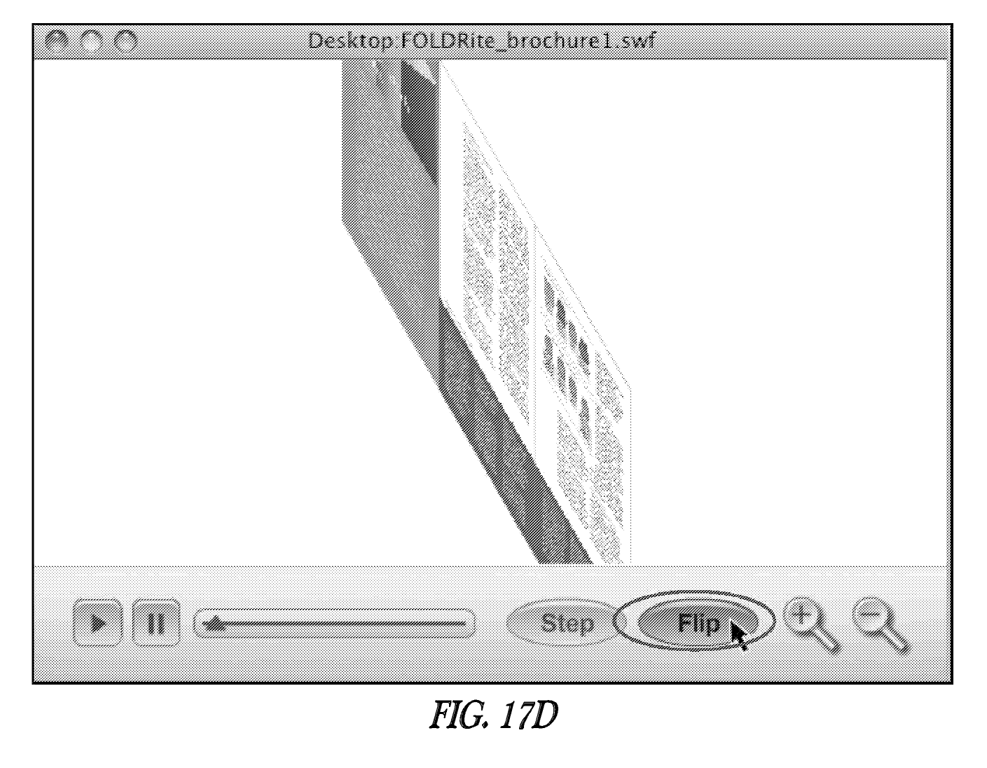

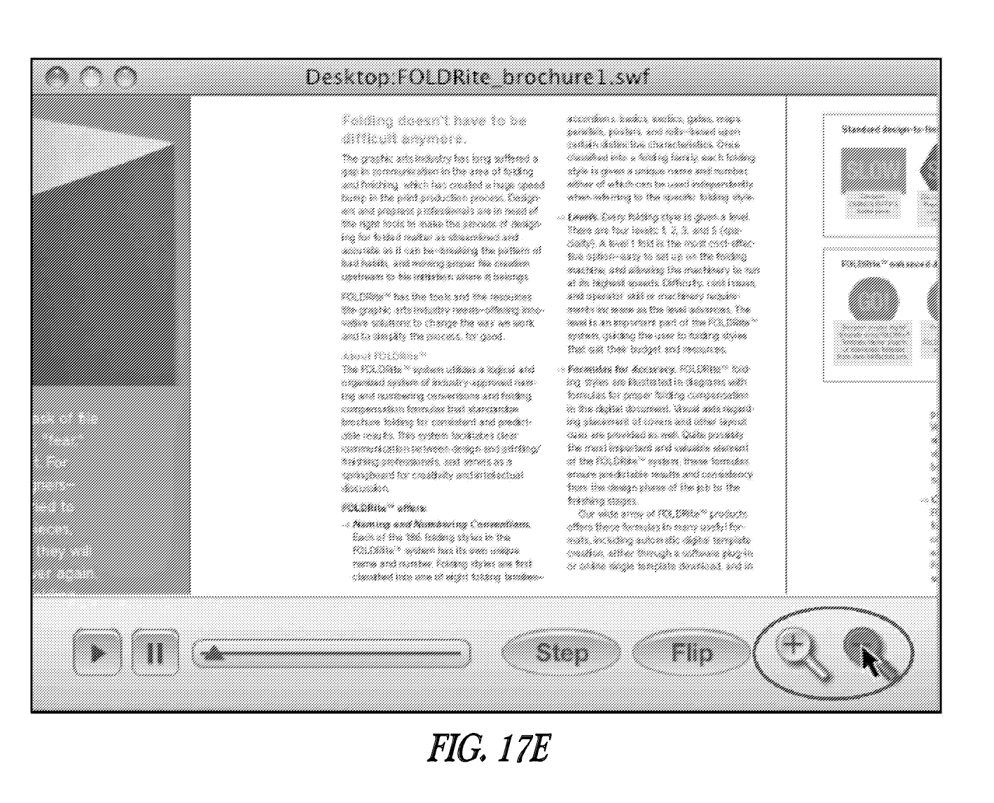

With reference to FIG. 17A, when the user opens the animation, they are presented with an interface as if they were looking at the finished and folded piece. A simple to use interface and buttons will be at the bottom of the main animation area.

### Slider Animation

With reference to FIG. 17B, a slider at the bottom of the main animation allows the user to:
1. Play the animation all the way through from beginning to end.
2. Pause the animation at any point in the process.
   Control the animation with a slider to navigate the full animation.

### Animation Step

With reference to FIG. 17C, this feature allows the user to click the ‘step’ button to advance the animation to the next panel action of the folding style.

### Animation Flip

With reference to FIG. 17C, this button will ‘flip’ the animation from the ‘front’ side to the ‘back’ side of the printed brochure. All ‘step’ and ‘play’ features will work showing the reverse side of the animation.

### Animation Zoom

With reference to FIG. 17E, the zoom in and zoom out features will allow the user to magnify the folding sample at one or two times magnification.

Example Job Message

```
<?xml version=“1.0” encoding=“UTF-8”?>
<JDF
  DescriptiveName=“Folded brochure ”
  ID=“Print_Shop_Live_042244488” JobPartID=“Print_Shop_Live_042244488”
  MaxVersion=“1.3” Status=“Waiting” Type=“Product” Version=“1.3”
  xmlns=“http://www.CIP4.org/JDFSchema_1_1”
  xmlns:xsi=“http://www.w3.org/2001/XMLSchema-instance”
xsi:type=“Product”>
  <AuditPool>
    <Created AgentName=“FOLDRite JDF Creator” AgentVersion=“b0.3”
      Author=“Finishing Experts Group” TimeStamp=“2008-09-28T18:49:05-
04:00”/>
  </AuditPool>
  <JDF DescriptiveName=“Prep, Print and Folding Process”
    ID=“PSL_Job_042244488” JobPartID=“Production Instructions”
    Status=“Waiting” Type=“ProcessGroup” xsi:type=“ProcessGroup”>
    <JDF DescriptiveName=“Cutting” ID=“ProcessCutting”
      JobPartID=“Cut000” Status=“Waiting” Type=“ProcessGroup”
      Types=“ProcessPrepress ProcessImposition ProcessPrinting”
xsi:type=“ProcessGroup”>
      <ResourceLinkPool>
        <ComponentLink Usage=“Input” rRef=“Printed_Press_Sheets”/>
        <CuttingParamsLink Usage=“Input” rRef=“CuttingParams”/>
        <ComponentLink Amount=“225” Usage=“Output” rRef=“Cut_Sheets”/>
        <DeviceLink Usage=“Input” rRef=“Duplo_DC645”/>
      </ResourceLinkPool>
      <ResourcePool>
        <CuttingParams Class=“Parameter” ID=“CuttingParams”
          PartIDKeys=“SignatureName SheetName” Status=“Available”>
          <CuttingParams SignatureName=“SIG_1”>
            <CuttingParams SheetName=“SHT_1”>
              <CutBlock BlockName=“Block0” BlockSize=“1296.00 864.00”
                BlockSubdivision=“1.0 1.0”
                BlockTrf=“1.0 0.0 0.0 1.0 43.20 36.00”
BlockType=“CutBlock”/>
            </CuttingParams>
          </CuttingParams>
        </CuttingParams>
      </ResourcePool>
    </JDF>
    <JDF DescriptiveName=“Broadside Front-Opening Double Parallel”
      ID=“ProcessFolding” JobPartID=“Fold000” Status=“Waiting”
      Type=“ProcessGroup”
      Types=“ProcessPrepress ProcessImposition ProcessPrinting
ProcessCutting” xsi:type=“ProcessGroup”>
      <ResourceLinkPool>
        <FoldingParamsLink Usage=“Input” rRef=“FOLDRite_P1”/>
        <ComponentLink Usage=“Output” rRef=“Folded_Output”/>
        <ComponentLink Usage=“Input” rRef=“Cut_Sheets”/>
        <DeviceLink Usage=“Input” rRef=“Duplo_DC645”/>
      </ResourceLinkPool>
      <ResourcePool>
        <FoldingParams Class=“Parameter”
          DescriptiveName=“FOLDRite P1 Folding Instructions”
          FoldCatalog=“F8-2” ID=“FOLDRite_P1” Status=“Available”>
          <Fold Class=“Parameter” From=“Front” To=“Down”
Travel=“645.75”/>
          <Fold Class=“Parameter” From=“Front” To=“Down”
Travel=“325.13”/>
        </FoldingParams>
      </ResourcePool>
    </JDF>
    <JDF Category=“MISPRE.ImpositionPreparation”
      DescriptiveName=“Imposition Preparation” ID=“ProcessImposition”
      JobPartID=“Imposition000” Status=“Waiting” Type=“ProcessGroup”
      Types=“ProcessImposition” xsi:type=“ProcessGroup”>
      <ResourceLinkPool>
        <StrippingParamsLink Usage=“Input” rRef=“STP000”/>
        <AssemblyLink Usage=“Input” rRef=“Assembley000”/>
        <LayoutLink Usage=“Output” rRef=“Digital_Press_Layout”/>
        <RunListLink ProcessUsage=“Marks” Usage=“Output”
rRef=“RNL000_Marks”/>
      </ResourceLinkPool>
      <ResourcePool/>
    </JDF>
    <JDF Category=“MISPRE.PrePressPreparation”
      DescriptiveName=“PrePress File Preparation” ID=“ProcessPrepress”
      JobPartID=“Prepress000” Status=“Waiting” Type=“ProcessGroup”
      Types=“ProcessPrepress” xsi:type=“ProcessGroup”>
      <ResourceLinkPool>
        <RunListLink ProcessUsage=“Document” Usage=“Input”
rRef=“File_042244488_delivered”/>
        <RunListLink ProcessUsage=“Document” Usage=“Output”
rRef=“File_042244488_prepped”/>
      </ResourceLinkPool>
      <ResourcePool/>
    </JDF>
    <JDF Category=“MISPRE.Printing” DescriptiveName=“Digital Printing”
      ID=“ProcessPrint” JobPartID=“Printing000” Status=“Waiting”
      Type=“ProcessGroup” Types=“ProcessPrepress ProcessImposition”
xsi:type=“ProcessGroup”>
      <ResourceLinkPool>
        <RunListLink ProcessUsage=“Document” Usage=“Input”
rRef=“File_042244488_prepped”/>
        <RunListLink ProcessUsage=“Marks” Usage=“Input”
rRef=“RNL000_Marks”/>
        <LayoutLink Usage=“Input” rRef=“Digital_Press_Layout”/>
        <DigitalPrintingParamsLink Usage=“Input”
rRef=“DigitalPrintingParams”/>
        <ColorantControlLink Usage=“Input” rRef=“ColorantControl”/>
        <InterpretingParamsLink Usage=“Input”
rRef=“InterpretingParams”/>
        <DeviceLink Usage=“Input” rRef=“Kodak_M700”/>
        <MediaLink Usage=“Input” rRef=“Press_Paper”/>
        <ComponentLink Amount=“225” Usage=“Output”
rRef=“Printed_Press_Sheets”/>
      </ResourceLinkPool>
      <ResourcePool>
        <DigitalPrintingParams Class=“Parameter” Collate=“None”
          ID=“DigitalPrintingParams” PrintingType=“SheetFed”
          SheetLay=“Left” Sides=“TwoSidedFlipY” Status=“Available”/>
      </ResourcePool>
    </JDF>
    <ResourcePool>
      <!-- Information on paper used is usefull for prepress color
corrections/ color books -->
      <Assembly Class=“Parameter” ID=“Assembley000” Order=“None”
Status=“Available”/>
      <BinderySignature Class=“Parameter” FoldCatalog=“F8-2”
        ID=“Fold_Catalog_ID” Status=“Available”/>
      <Component Class=“Quantity” ComponentType=“Sheet”
        DescriptiveName=“Printed and cut sheets”
        Dimensions=“1296.00 864.00 0.00” ID=“Cut_Sheets”
        ReaderPageCount=“2” Status=“Unavailable”/>
      <Component Class=“Quantity” ComponentType=“Sheet”
        DescriptiveName=“Printed sheet” Dimensions=“1382.40 936.00 0”
        ID=“Printed_Press_Sheets” ReaderPageCount=“2”
Status=“Unavailable”/>
      <InterpretingParams Class=“Parameter” ID=“InterpretingParams”
Status=“Available”>
        <MediaRef rRef=“Press_Paper”/>
      </InterpretingParams>
      <RunList Class=“Parameter”
        DescriptiveName=“Pages for platemaking brochure”
        ID=“File_042244488_delivered” NPage=“2” Status=“Available”>
<LayoutElement>
          <FileSpec MimeType=“application/pdf”
URL=“Content/042244488.pdf”/>
        </LayoutElement>
      </RunList>
      <RunList Class=“Parameter” ID=“File_042244488_prepped”
Status=“Unavailable”/>
      <RunList Class=“Parameter” ID=“RNL000_Marks”
Status=“Unavailable”/>
      <StrippingParams Class=“Parameter” ID=“STP000”
        PartIDKeys=“SignatureName SheetName” Status=“Available”>
        <StrippingParams SignatureName=“SIG_1”>
          <StrippingParams DescriptiveName=“Sheet 1” SectionList=“0”
            SheetName=“SHT_1” WorkStyle=“WorkAndTurn”>
            <!-- Bleed looks a bit smaller as usual, Trim is set to 0
since this is a folded brochure, no overfold or milling-->
            <DeviceRef rRef=“Kodak_M700”/>
            <MediaRef rRef=“Press_Paper”/>
            <Position MarginBottom=“36.00” MarginLeft=“43.20”
              MarginRight=“43.20” MarginTop=“36.00”
              Orientation=“Rotate0” RelativeBox=“0.00 0.00 1.00 1.00”/>
            <BinderySignatureRef rRef=“Fold_Catalog_ID”/>
          </StrippingParams>
        </StrippingParams>
      </StrippingParams>
    </ResourcePool>
  </JDF>
  <ResourceLinkPool>
    <ComponentLink Usage=“Output” rRef=“Folded_Output”/>
    <FoldingIntentLink Usage=“Input” rRef=“Intent_FOLDRite_P1”/>
    <NodeInfoLink Usage=“Input” rRef=“PSL_042244488”/>
    <DeliveryIntentLink Usage=“Input” rRef=“Delivery_PSL_042244488”/>
    <CustomerInfoLink Usage=“Input” rRef=“Contact_Information”/>
  </ResourceLinkPool>
  <ResourcePool>
    <ColorPool Class=“Parameter” DescriptiveName=“Colors for the job”
      ID=“ColorPool” Status=“Available”>
      <Color CMYK=“1 0 0 0” Name=“Cyan”/>
      <Color CMYK=“0 1 0 0” Name=“Magenta”/>
      <Color CMYK=“0 0 1 0” Name=“Yellow”/>
      <Color CMYK=“0 0 0 1” Name=“Black”/>
    </ColorPool>
    <ColorantControl Class=“Parameter”
      DescriptiveName=“Colors of the job” ID=“ColorantControl”
Status=“Available”>
      <ColorantParams>
        <SeparationSpec Name=“Cyan”/>
        <SeparationSpec Name=“Magenta”/>
        <SeparationSpec Name=“Yellow”/>
        <SeparationSpec Name=“Black”/>
      </ColorantParams>
      <ColorPoolRef rRef=“ColorPool”/>
    </ColorantControl>
    <Component Class=“Quantity” ComponentType=“FinalProduct”
      DescriptiveName=“Folded sheet” Dimensions=“432.00 864.00 0”
      ID=“Folded_Output” ReaderPageCount=“2” Status=“Unavailable”/>
    <CustomerInfo BillingCode=“PSL_0001” Class=“Parameter”
      CustomerID=“100001” CustomerJobName=“Print_Shop_Live_042244488”
      CustomerOrderID=“Print_Shop_Live_042244488”
      ID=“Contact_Information” PartUsage=“Implicit” Status=“Available”>
      <Contact ContactTypes=“Customer”>
        <Company OrganizationName=“Finishing Experts Group”/>
        <Person DescriptiveName=“Mark Witkowski” FamilyName=“Witkowski”
          FirstName=“Mark” JobTitle=“Vice President”>
          <ComChannel ChannelType=“Email”
Locator=“mark@foldfactory.com”/>
        </Person>
        <ComChannel ChannelType=“Email”
Locator=“mark@foldfactory.com”/>
        <Address City=“Dexter” Country=“United States of America”
          CountryCode=“US” PostalCode=“48130” Street=“7492 Timber Ridge
Ct. Suite 120”/>
      </Contact>
      <Contact ContactTypes=“Billing”>
        <Company OrganizationName=“Finishing Experts Group”/>
        <Person DescriptiveName=“Mark Witkowski” FamilyName=“Witkowski”
          FirstName=“Mark” JobTitle=“Vice President”>
          <ComChannel ChannelType=“Email”
Locator=“mark@foldfactory.com”/>
        </Person>
        <ComChannel ChannelType=“Email”
Locator=“mark@foldfactory.com”/>
        <Address City=“Dexter” Country=“United States of America”
          CountryCode=“US” PostalCode=“48130” Street=“7492 Timber Ridge
Ct. Suite 120”/>
      </Contact>
    </CustomerInfo>
    <DeliveryIntent Class=“Intent” DescriptiveName=“Delivery”
      ID=“Delivery_PSL_042244488” Status=“Available”>
      <DropIntent>
        <Method Actual=“BestWay” DataType=“NameSpan”
Preferred=“BestWay”/>
        <Required Actual=“2002-10-06T17:00:00-04:00”
DataType=“TimeSpan” Preferred=“2002-10-06T17:00:00-04:00”/>
        <DropItemIntent Amount=“225” OrderedAmount=“225” Unit=“Folded
Brochures”>
          <ComponentRef rRef=“Folded_Output”/>
        </DropItemIntent>
        <Contact ContactTypes=“Delivery”>
          <Company OrganizationName=“Finishing Experts Group”/>
          <Person DescriptiveName=“Mark Witkowski”
            FamilyName=“Witkowski” FirstName=“Mark” JobTitle=“Vice
President”>
            <ComChannel ChannelType=“Email”
Locator=“mark@foldfactory.com”/>
          </Person>
          <ComChannel ChannelType=“Email”
Locator=“mark@foldfactory.com”/>
          <Address City=“Dexter” Country=“United States of America”
            CountryCode=“US” PostalCode=“48130” Street=“7492 Timber
Ridge Ct. Suite 120”/>
        </Contact>
      </DropIntent>
    </DeliveryIntent>
    <Device Class=“Implementation”
      DescriptiveName=“Slitter Cutter Creaer Folder”
      DeviceID=“Duplo_DC645” FriendlyName=“Duplo_DC645”
ID=“Duplo_DC645”
      Manufacturer=“Duplo” ModelNumber=“DC645” Status=“Available”/>
    <Device Class=“Implementation” DescriptiveName=“Digital Press”
      DeviceID=“Kodak_M700” FriendlyName=“Kodak_M700” ID=“Kodak_M700”
      Manufacturer=“Kodak” ModelNumber=“M700” Status=“Available”/>
    <FoldingIntent Class=“Intent”
      DescriptiveName=“FOLDRite P1 - Broadside Front-Opening Double
Parallel”
      ID=“Intent_FOLDRite_P1” Status=“Available”>
      <FoldingCatalog Actual=“F8-2” DataType=“NameSpan”/>
    </FoldingIntent>
    <Layout Class=“Parameter” ID=“Digital_Press_Layout”
      Name=“CoverLayout” PartIDKeys=“SignatureName SheetName Side”
Status=“Unavailable”>
      <Layout Name=“BrochureLayout” SignatureName=“SIG_1”>
        <Layout Name=“BrochureLayout” SheetName=“SHT_1”>
          <MediaRef rRef=“Press_Paper”/>
          <Layout Name=“BrochureLayout” Side=“Front”/>
        </Layout>
      </Layout>
    </Layout>
    <Media Amount=“225” BackCoatings=“Coated” Brand=“Sappi”
      Class=“Consumable” DescriptiveName=“This information is to come.”
      Dimension=“1382.40 936.00” FrontCoatings=“Coated” Grade=“1”
      GrainDirection=“LongEdge” ID=“Press_Paper” MediaType=“Paper”
      ProductID=“PAP351052N2HA” Status=“Available” Thickness=“110”
Weight=“100”/>
    <NodeInfo Class=“Parameter” ID=“PSL_042244488” PartUsage=“Implicit”
Status=“Available”>
      <BusinessInfo>
        <pt:Quotation AgentDisplayName=“John Smith” AgentID=“John”
          BusinessID=“Quote_744910” BusinessRefID=“RFQ_744910”
          Currency=“USD” Estimate=“false”
          Expires=“2002-10-29T17:07:22-04:00”
          RequestDate=“2002-09-29T17:07:22-04:00”
xmlns:pt=“http://www.printtalk.org/schema”>
          <Quote Amount=“225” Currency=“USD”
            DescriptiveName=“Folded brochure ”
            QuoteID=“Quote_1” Unit=“Brochures”>
            <Pricing>
              <Price DescriptiveName=“Total” LineID=“DI1_1”
Price=“300.00”/>
              <Price DescriptiveName=“Discount” LineID=“DI2_2”
Price=“5.40”/>
              <Price DescriptiveName=“ Shipping and Handling”
                LineID=“DI3_3” Price=“12.00”/>
              <Price DescriptiveName=“Tax” LineID=“DI4_4”
Price=“4.00”/>
              <Payment PayTerm=“2% 10, Net 30”/>
            </Pricing>
          </Quote>
        </pt:Quotation>
      </BusinessInfo>
    </NodeInfo>
  </ResourcePool>
</JDF>
```

### Functional Outline

### Summary

This is to provide a functional specification for the FOLDRite™ template Master plug-in. This cross-platform tool will provide an environment for users of Adobe InDesign and QuarkXPress to enter parameters into an interface and have a resulting FOLDRite folding template built for them in real-time.

### Product Description

The FOLDRite plug-in is innovative in its ability to streamline a part of the production process that has never been automated before. Using industry-approved folding compensation formulas with the users' custom settings, FOLDRite creates a ready-to-use folding template.

The FOLDRite plug-in is a plug-in for Adobe InDesign that works seamlessly with the intended software package, in both Mac and Windows platforms—something that looks good, is user-friendly and intuitive in its design, and lightning fast and accurate in its functions. The FOLDRite plug-in can be ported to QuarkXPress.

### User Characteristics

The targeted user for this plug-in is the professional designer who uses InDesign or QuarkXPress, as well as the education market—design students and their teachers. On the printing side of the industry, prepress departments would greatly benefit from the product, correcting files that were not created as FOLDRite templates, or sending clients FOLDRite templates. Our intent is to also offer branded versions of the plug-in with customized preferences for printing companies to guide their clients into working within the limits of their machinery and skill sets.

### The Top-Level Program Structure

The application will be broken out into several layers—a plug-in, a user interface and Java scripts to control InDesign.

| Program | Task |
|---|---|
| InDesign | To insert a menu into InDesign for an end user to start the |
| Plug-in | process. When selected this menu will call out to the |
| | external REALbasic application. |
| REALbasic | This is the primary UI and will carry all of the logic for |
| Application | selecting folds and gathering user parameters. This can be |
| | cross-platform. |
| Java Scripts | These scripts will accept the parameters from the |
| | REALbasic UI and control InDesign for the template |
| | building process. Currently these scripts are coded in |
| | AppleScript and need to be converted/tested as Java. |

### Version Planning

Version 1

| | |
|---|---|
| Folding | Dynamic folding template creation |
| | Retroactive template application |
| | Live template edit/change without having to change page content |
| | Create folding templates by |
| | custom finished size |
| | envelope enclosure size |
| | standard sheet size |
| Binding | — |
| Mailing | — |
| Prepress | Retroactive application of all templates |
| | Printer profile to constrain (in conjunction with and overall |
| | InDesign printer profile and preferred setup) |
| | max width |
| | styles available |
| | stock issues |
| | contact info |
| Other | — |

Version 2

| | |
|---|---|
| Folding | Add BRC panel or short flaps to modify |
| Binding | Cover/dust jacket builder (automatically calculates spine bulk |
| | and builds file) |
| | Sets bind margins in document for different binding styles: |
| | Mechanical binding-sets 3-hole, 5-hole, etc. drill die and bind |
| | margin |
| | Sets grind-off zone and bind margin for adhesive binding, etc. |
| | Saddle stitch shingling |
| Mailing | Postal Wizard-guides and graphics provided and builds to |
| | conform with USPS standards |
| | Folding-format suggestions and fold templates best suited for |
| | direct mail |
| | BRC/BRE creator |
| Prepress | JDF integration/population |
| | Template verification in preflight tools |
| | Integrate settings into preflight tools and document info |
| Other | Envelopes - standard and custom |

Version 3

| | |
|---|---|
| Folding | — |
| Binding | — |
| Mailing | — |
| Prepress | Imposition help tool (Metrix?) suggests scenarios for optimum |
| | production |
| Other | Newsletters-choose from standard folding styles and column |
| | set-up (which would include masthead space allocation, |
| | footers/folios, mailing area) |
| | Postcards |
| | Pocket folders |
| | CD and CD jacket |
| | Bus wraps/car wraps |
| | Billboards/large format |
| | Forms-templates and graphics to pull from for easy form |
| | creation |

### Accessing the Plug-In

The first step in the process will begin with the user in InDesign. The user would be able to launch the plug-in from within InDesign, by choosing File>New>FOLDRite Template from the top navigation menu. A splash screen with the logo and copyright info would appear and disappear quickly. FIG. 18 outlines the menu options.

### The User Interface

The process is kept simple and intuitive with a single interface, rather than creating several interfaces for the user to travel through.

The program includes two tabs at the top—Folding and Preferences. Folding is the default window that appears. This sets the format for the FOLDRite Template Master, where additional tabs can span across the top and provide features, such as Folding, Binding, Direct Mail, Other, Prepress, and Preferences. In Windows terminology, these views are called property sheets.

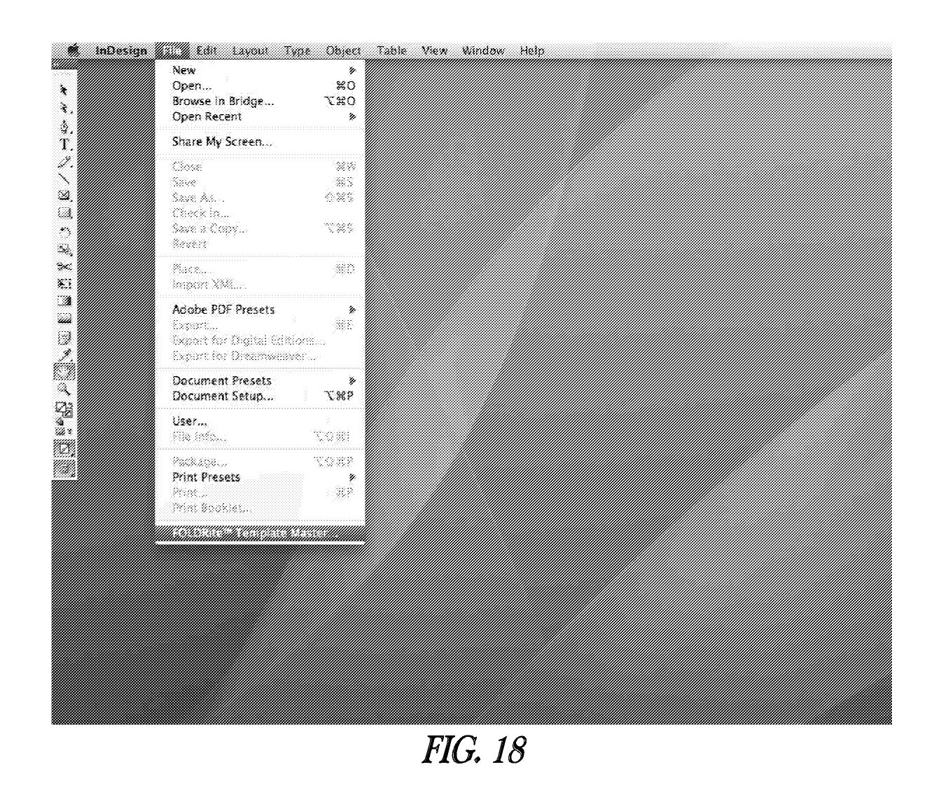

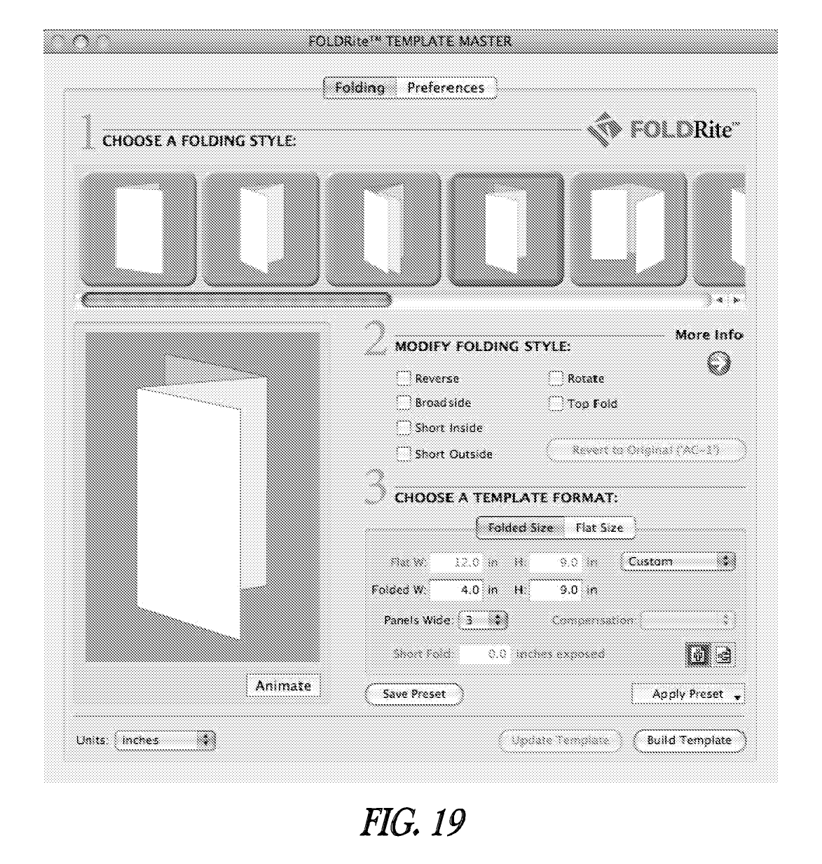

The interface is labeled in three phases, with the numbers 1, 2 and 3 to guide the user through the process. FIG. 19 outlines the main user interface.

### Main User Interface

The first phase is to choose a folding style, unless the user plans to choose from an existing library of folding templates—a process that will be explained in phase three. Small images of the base set of folding styles are accessible using a slider menu that travels horizontally across the top. The user can roll over the folding styles or click on their choice, which will cause the image in the large window to change, reflecting an enlarged version of the small image that has been selected. The name of the folding style will also appear in the large window directly underneath the image of the folding style. A Flash animation of the folding style will be engaged if the “Animate” box is activated

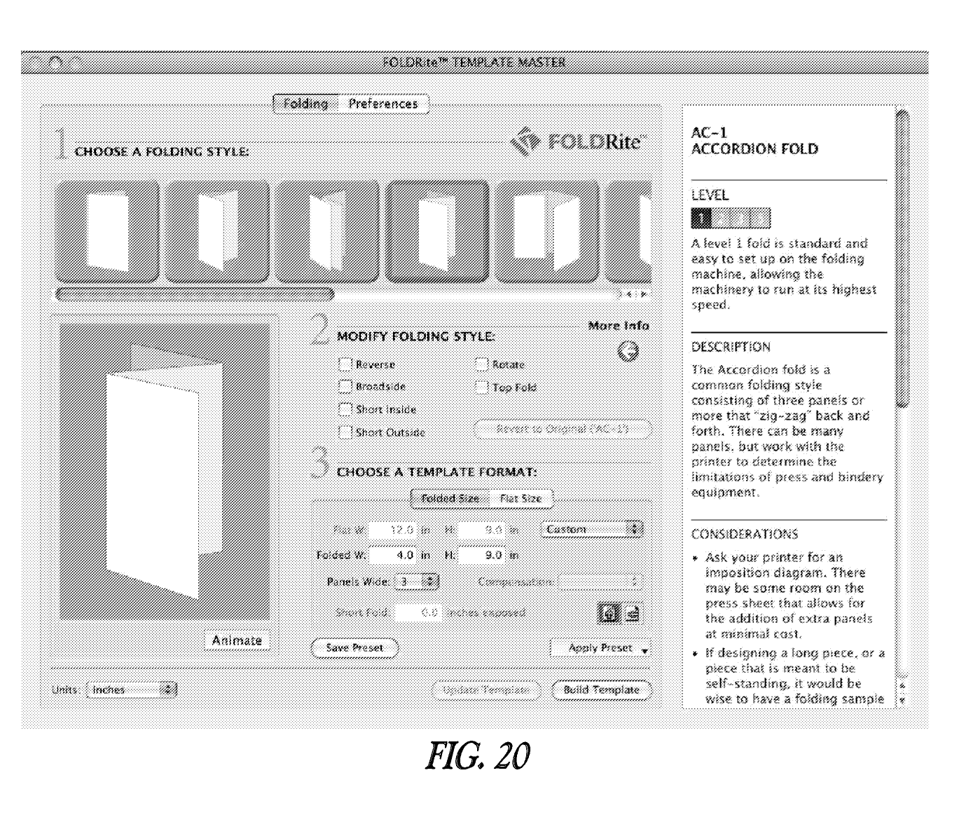

On the far right side of the UI, directly under the horizontal slider is a More Info button. When clicked, a drawer slides out displaying additional information about the selected folding style—its level of difficulty, a description, and considerations. FIG. 20 illustrates this function.

### Main User Interface

Once the folding style has been chosen, the user has the option of modifying that style to further customize it to their specifications. This feature gives the user a lot of control and access to a much larger variety of FOLDRite folding styles. See the Folding Button options table for guidance.
By default, the Standard button is selected and indicates that the fold chosen from the base set is the desired folding style.
The Reverse button reverses the direction of the folding style, accessing the reverse version of the fold—for example, changing the AC-1 accordion fold to the AC-7 reverse accordion fold. This command does not apply to all base folds, and therefore, folding styles that cannot be modified in this format will have a grayed-out reverse button.
The Broadside button creates a broadside version of the folding style, accessing the broadside version of the fold—for example, changing the AC-1 accordion fold to the AC-2 broadside accordion fold. This command does not apply to all base folds, and therefore, folding styles that cannot be modified in this format will have a grayed-out broadside button.
The Top Fold button creates a version of the folding style with the fold at the top, accessing the top fold version of the fold. This command does not apply to all base folds, and therefore, folding styles that cannot be modified in this format will have a grayed-out Top Fold button.
The Rotate button turns the folding style, accessing the vertical version of the fold—for example, changing the AC-1 accordion fold to the AC-5 vertical accordion fold.
The Short Fold button creates a short fold. This function is slightly more complicated, due to the choices the user must make. The Inside and Outside radial buttons and the Exposed Area field are grayed out unless Short Fold is selected. The user must decide if the short fold will be to the inside or outside of the piece, and must choose one or the other. The default choice will be inside. Next, they must choose how short the short fold will be by entering a measurement in the exposed area field—a number that cannot be more than half of the height of the piece. This command does not apply to all base folds, and therefore, folding styles that cannot be modified in this format will have a grayed-out short fold button.
A user can combine modifiers (if the folding style exists) by Shift-clicking the buttons. For example, the user could create an AC-8 Broadside Reverse Accordion by first choosing the AC-1 Accordion base fold and then shift-clicking the Reverse and Broadside buttons.
Folding style button functions

Standard

| | | | Short | Short | | |
|---|---|---|---|---|---|---|
| | Standard | Broadside | Fold (in) | Fold (out) | Rotated | Top |
| AC1 | AC1 | AC2 | AC3 | AC4 | AC5 | M1 |
| AC16 | AC16 | AC17 | AC18 | AC19 | — | AC20 |
| AC38 | AC38 | — | — | — | — | — |
| B1 | B1 | B3 | B4 | B5 | B7 | B6 |
| B3 | B3 | Above? | | | | |
| B9 | B9 | B10 | B11 | B12 | B13 | B16 |
| G1 | G1 | G2 | G3 | G4 | G5 | G6 |
| P1 | P1 | P2 | P3 | P4 | P5 | P7 |
| P17 | P17 | P18 | P19 | P20 | — | — |
| P21 | P21 | P22 | P23 | P24 | P25 | — |
| R1 | R1 | R2 | R3 | R4 | R5 | R7 |
| M1 | M1 | — | — | — | — | — |

Reverse

| | | | Short | Short | | |
|---|---|---|---|---|---|---|
| | Reverse | Broadside | Fold (in) | Fold (out) | Rotated | Top |
| AC1 | AC7 | AC8 | AC9 | AC10 | AC11 | M2 |
| AC16 | AC21 | AC22 | AC23 | AC24 | — | AC25 |
| AC38 | — | — | — | — | — | — |
| B1 | — | — | — | — | — | — |
| B3 | Above? | — | — | — | — | — |
| B9 | — | — | — | — | — | — |
| G1 | — | — | — | — | — | — |
| P1 | P8 | P9 | P10 | P11 | P12 | P14 |
| P17 | — | — | — | — | — | — |
| P21 | P27 | P28 | P29 | P30 | P31 | — |
| R1 | R8 | R9 | R10 | R11 | — | R12 |
| M1 | — | — | — | — | — | — |

Special Combinations
Rotated & Broadside
Standard AC1 = AC6
Reverse AC1 = AC12
Standard B9 = B15
Standard P1 = P6
Reverse P1 = P13
Standard P21 = P26
Reverse P21 = P32
Standard R1 = R6

### Main User Interface

The last phase in the process is to choose a template format. There are four options—to enter custom measurements, to create a template that fits a specific standard cut sheet size, to create a template that is sized to a specific enclosure size for an envelope, or to choose from a library of saved templates.

The Custom tab provides fields for the user to enter a finished height and width, with which the FOLDRite engine will calculate the compensated flat size. User can also choose Normal, Increased or Heavy compensation, with Normal as the default. Another option, if applicable, is to choose Panels Wide or Long (see interface variables table for guidance).

### The Importance of Folding Compensation

What looks like a folding mistake by the bindery is often designer error. It's important to understand that paper is dimensional, and if a panel of a brochure is to fold into another, it must be slightly smaller to accommodate for the thickness of the sheet and for the subtle process variation in machine folding. If this critical adjustment is not made, the result will be what's called “telescoping,” or the inability for the folded piece to lay flat. The brochure will have a roundish profile because the panels are too long and push against each other for lack of anywhere else to go. The bindery worker will adjust the placement of the folds so the piece will lay flat, but margins and color breaks will shift noticeably—ultimately causing client disappointment.

This problem is totally preventable if a proper folding template is used. FOLDRite Template Master was designed to address this industry-wide problem by providing ready-to-use dynamic folding templates. As one might imagine, if the fold becomes more complicated, the compensation placement and allowances get more complicated as well, but Template Master does all the work in the background using industry-approved folding compensation algorithms. Simply build your template and start designing—it's that simple.

### Which Compensation Amount Should I Use?

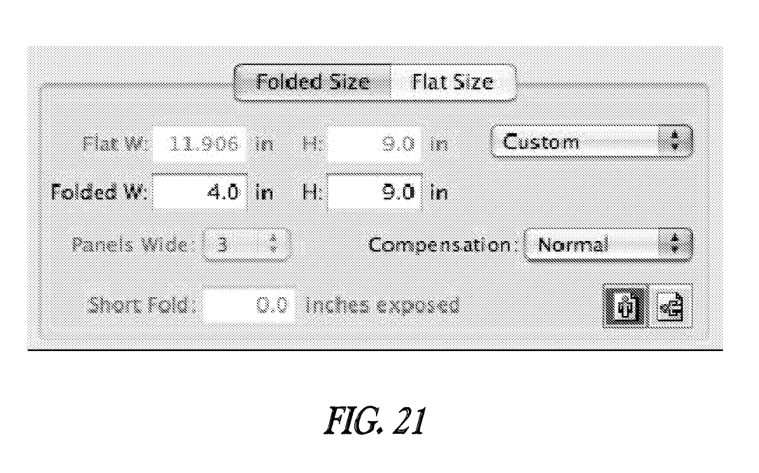

When choosing a folding compensation amount, the choices are Normal, Increased and Heavy. In most cases, the “Normal” setting will be what is most appropriate, since it is based on an industry-approved mathematical measurement. However, we offer the option to incrementally increase the amount of compensation to accommodate for a cover weight sheet, or for a preference to have a very generously compensated product. For an example a of user interface for managing folding compensation preferences, see FIG. 21.

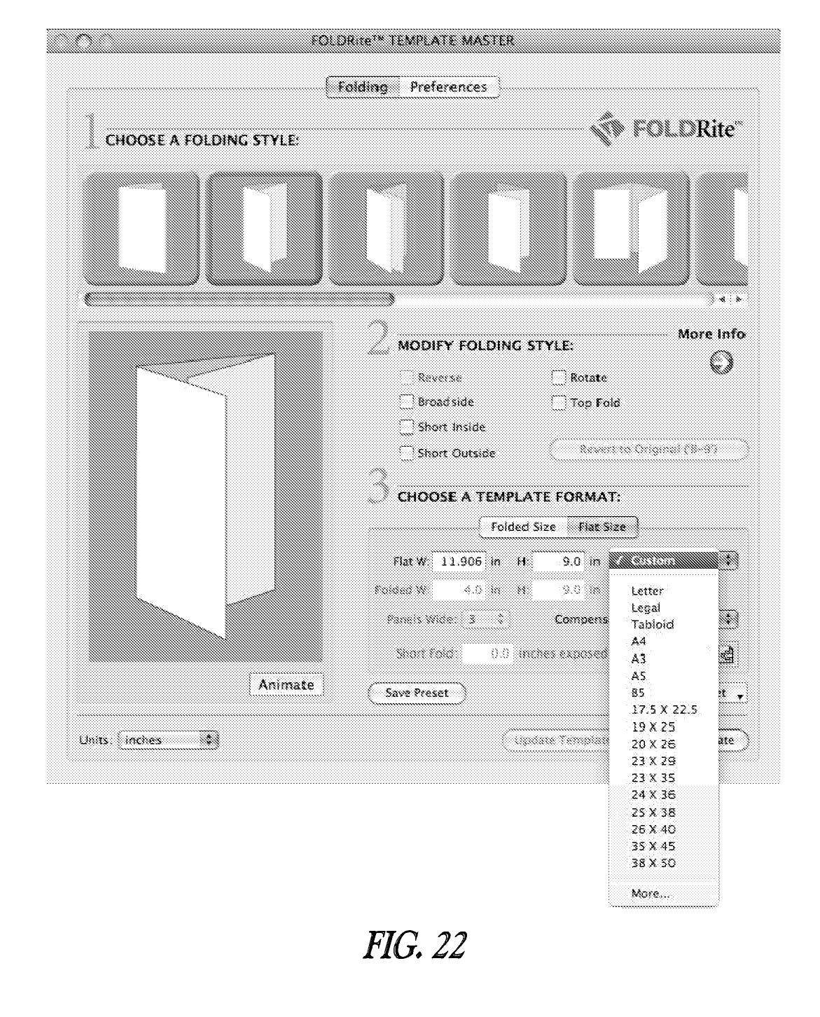

The Cut Sheet tab allows the user to create templates that are built to the exact flat size of a standard cut sheet by choosing from a drop menu of sizes, such as 8.5×11, A4, etc. Other options in that tab are compensation amount, and, if applicable, Panels Wide/Long. FIG. 22 illustrates this function.

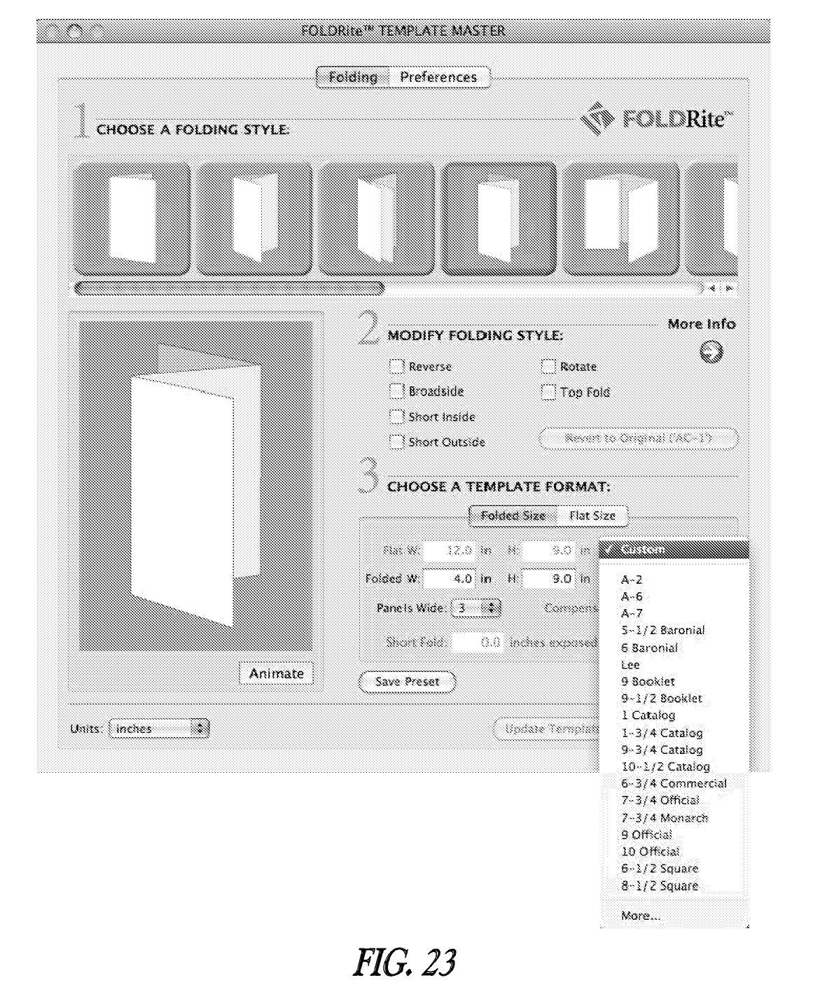

The Envelope tab allows the user to create templates that are built to specific enclosure sizes that fit envelopes by choosing from a drop menu of sizes, such as #10, A4, etc. Other options in that tab are compensation amount, and, if applicable, Panels Wide/Long. There will also be a link that, when clicked, will open a window with additional envelope sizing information. FIG. 23 illustrates this function.

The Library tab contains a drop menu that lists all templates that the user has saved into the library (these are saved as an XML document of the fold parameters) by shift-clicking the Build Template button.
A shift-click on the Build Template button changes the button to Save to Library and the template can be named and will then appear in the library drop menu. Shift-clicking the button will still build the template, while adding it to the library as well.

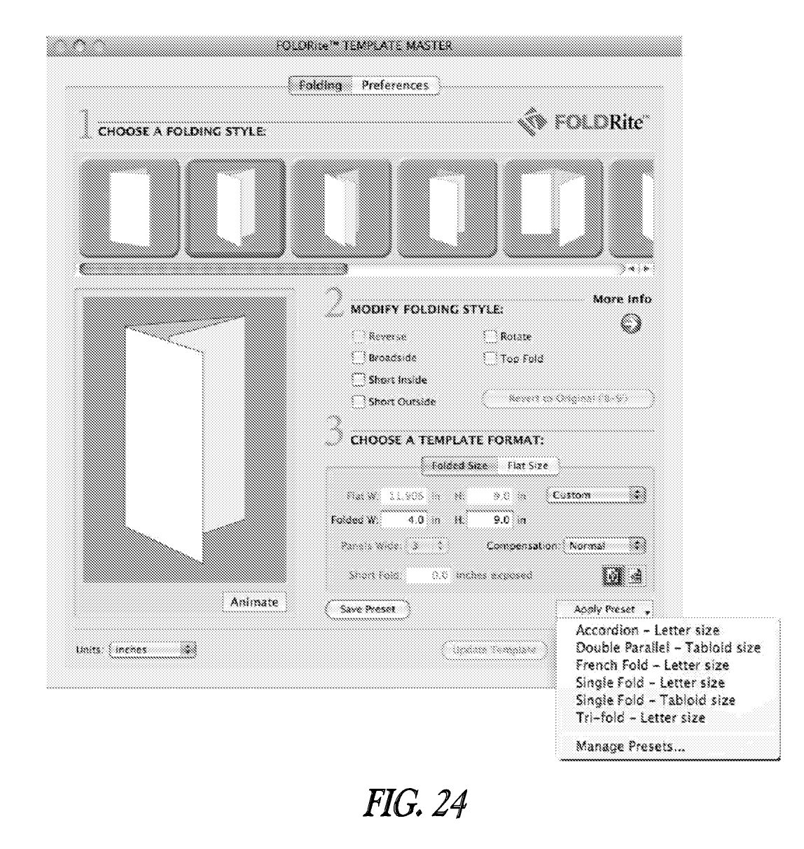

Two additional buttons are in this tab—Rename and Remove. Any library item that is selected can be renamed or removed by choosing it from the drop menu and clicking either the rename or remove button. Otherwise, selecting the item and choosing Build Template will create the template. In another example, this tab can be used to create library sets that can be saved by client name, etc. FIG. 24 illustrates this function.

### Main User Interface: Other Buttons

Along the bottom of the interface, there are four simple buttons—Animate, Units, Update Template, and Build Template.

Animate: As previously mentioned, the animate button enables a Flash animation in the large window. In an example, the animate button a check box. After activating the animate button, the animation loops a number of times, e.g., two or three times, when the button is clicked and then stops. In an example, a keystroke combination can be used, such as a shift-click of the animate button enables the animation to loop twice for every fold chosen without needing to keep clicking on it.
Units: The user may globally change the units of measurement in the interface by changing the units in the drop menu. The unit choice will also be reflected in the document units in the template.
Update Template: This exciting feature allows a user to change an existing FOLDRite template, or to modify an existing InDesign file that was not created as a FOLDRite template and turn it into a FOLDRite template without altering document content. To modify an existing FOLDRite template, for instance if the client changes the folding style and the designer must modify the document to reflect this choice, the designer can simply navigate to the FOLDRite template they intend to modify, change the settings in the user interface, and click the Update Template button. The FOLDRite engine will make the adjustments to the chosen file, reset the fold marks, etc., all without altering the document content. The designer can then move the layout elements on their own.
Another appropriate scenario for the Update Template button is to navigate to an existing InDesign file that was not built as a FOLDRite template, choose the template settings, and click Update Template. The FOLDRite engine will make the adjustments to the chosen file, reset the fold marks, etc., all without altering the document content. The designer or prepress person can then move the layout elements on their own.

Build Template: The Build Template button puts the FOLDRite engine in motion and builds the template for the user. A shift-click on the Build Template button changes the button to Save to Library and the template can be named and will then appear in the library drop menu. Shift-clicking the button will still build the template, while adding it to the library as well.
Roll overs: In an example, the buttons change color as the cursor is moved over them.

### The Resulting InDesign Template

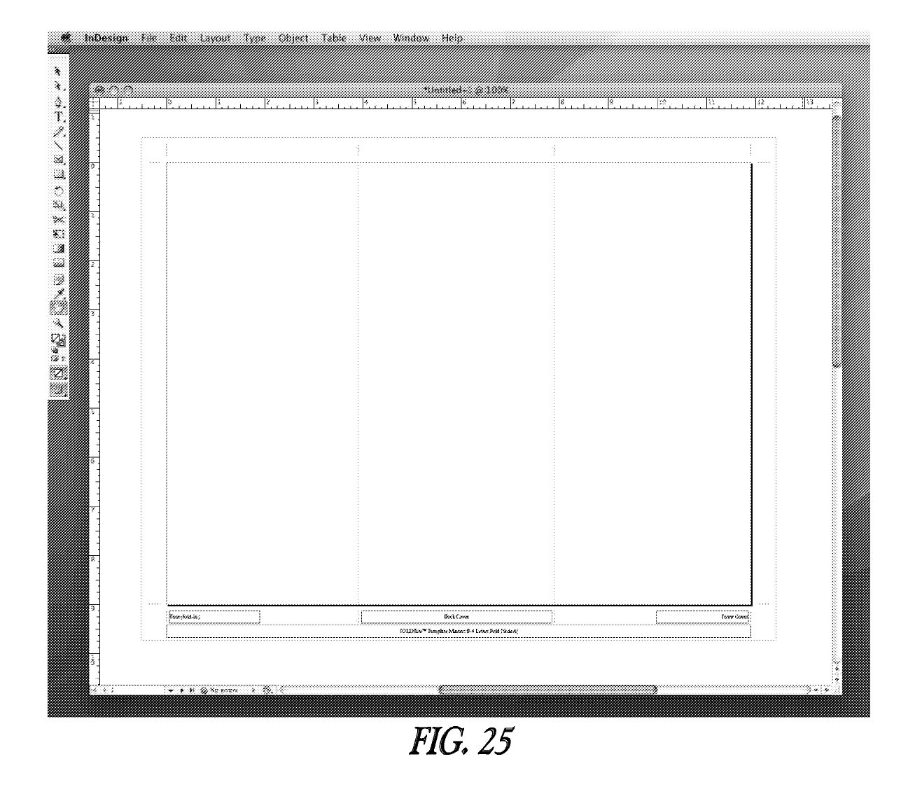

When the build button is clicked, Java scripts control InDesign to build the custom template. An example is illustrated in FIG. 25.

### User Preferences

When clicking on the Preferences tab at the top, the user can choose from following preferences:
Units of measure (inches, cm, mm, pts)
User information (in preparation for JDF usage)—Name, company, contact info, etc.
Default location to save templates
Select version of InDesign (if multiple installations exist)
Select the font to use for the template (and size)
Slug line content customization (user defined fields)
Change the folding guide color

### Items of Note

UI should check max width and height not to exceed ID's min and max sizes
UI should detect exposed area (in short fold) not to be larger than ½ the height
UI should detect and flag panel width lower than 1″
User can enter decimal inches or fractions
User can enter “pt” or “in” regardless of current preferences and over ride the current default measurement units
Include a unit conversion calculator available to the user
Place “Built by FOLDRite” on the pasteboard of each fold along with the template parameters
Add a slug line to indicate the folding template name and who built it
The FOLDRite guide layer may be locked and optionally, be password protected

### Additional Features and Functions

The product may include a pop-up help for each technical parameter (finished height, exposed area, etc.).
The product may also include an installer program.
How will the profile be edited for the printer profile? A stand-alone application for this can be used to edit the printer profile. In another example a text editor, or other editor application can be used. In an example, the printer profile is maintained as an XML file. In an example, the profile is encrypted.
In an example, when a designer has a set of printer preferences from 2 different sources, the UI can allow the user to choose, e.g., using a pop-up when the application is started that lists the organizations and the user must choose at that point
In an example, two interfaces are provided—one for a standard installation and one for an installation with “Print Service Provider preferences”
   1. The standard installation can have a very graphical interface and be limited to the base set of folds
   2. The printer version can have unlimited folds and may exceed or restrict the folds available relative to the base set.

### User Interface

### Technical Outline

### Summary

This is to provide a functional specification for the FOLDRite™ Template Master plug-in. This cross-platform tool will provide an environment for users of Adobe® ® InDesign® and QuarkXPress® to enter parameters into an interface and have a resulting FOLDRite™ folding template built for them in real-time.

### Product Description

The FOLDRite™ plug-in is innovative in its ability to streamline a part of the production process that has never been automated before. Using industry-approved folding compensation formulas with the users' custom settings, FOLDRite™ creates a ready-to-use folding template.

The FOLDRite™ plug-in is a plug-in for Adobe® InDesign® that works seamlessly with the intended software package, in both Mac® and Windows® platforms-something that looks good, is user-friendly and intuitive in its design, and lightning fast and accurate in its functions. The FOLDRite™ plug-in can be ported to QuarkXPress®.

### User Characteristics

The targeted user for this plug-in is the professional designer who uses InDesign® or QuarkXPress, as well as the education market—design students and their teachers. On the printing side of the industry, prepress departments would greatly benefit from the product, correcting files that were not created as FOLDRite™ templates, or sending clients FOLDRite™ templates. Our intent is to also offer branded versions of the plug-in with customized preferences for printing companies to guide their clients into working within the limits of their machinery and skill sets.

### The Top-Level Program Structure

The application will be broken out into several layers—a plug-in, a user interface and Java scripts to control InDesign®.

| Program | Task |
|---|---|
| InDesign ® | To insert a menu into InDesign ® for an end user to start |
| Plug-in | the process. When selected this menu will call out to the |
| | external REALbasic application. |
| REALbasic | This is the primary UI and will carry all of the logic for |
| Application | selecting folds and gathering user parameters. This can be |
| | cross-platform. |
| Java Scripts | These scripts will accept the parameters from the |
| | REALbasic UI and control InDesign ® for the template |
| | building process. Currently these scripts are coded in |
| | AppleScript ® and need to be converted/tested as Java ™. |

### Version Planning

Version 1

| | |
|---|---|
| Folding | Dynamic folding template creation |
| | Retroactive template application |
| | Live template edit/change without having to change page content |
| | Create folding templates by |
| | custom finished size |
| | envelope enclosure size |
| | standard sheet size |
| Binding | — |
| Mailing | — |
| Prepress | Retroactive application of all templates |
| | Printer profile to constrain (in conjunction with and overall |
| | InDesign ® printer profile and preferred setup) |
| | max width |
| | styles available |
| | stock issues |
| | contact info |
| Other | — |

Version 2

| | |
|---|---|
| Folding | Add BRC panel or short flaps to modify |
| Binding | Cover/dust jacket builder (automatically calculates spine bulk |
| | and builds file) |
| | Sets bind margins in document for different binding styles: |
| | Mechanical binding-sets 3-hole, 5-hole, etc. drill die and |
| | bind margin Sets grind-off zone and bind margin for adhesive |
| | binding, etc. Saddle stitch shingling |
| Mailing | Postal Wizard-guides and graphics provided and builds to |
| | conform with USPS standards |
| | Folding-format suggestions and fold templates best suited for |
| | direct mail BRC/BRE creator |
| Prepress | JDF integration/population |
| | Template verification in preflight tools |
| | Integrate settings into preflight tools and document info |
| Other | Envelopes - standard and custom |

Version 3

| | |
|---|---|
| Folding | — |
| Binding | — |
| Mailing | — |
| Prepress | Imposition help tool suggests scenarios for optimum production |
| Other | Newsletters-choose from standard folding styles and column |
| | set-up (which would include masthead space allocation, footers/ |
| | folios, mailing area) |
| | Postcards |
| | Pocket folders |
| | CD and CD jacket |
| | Bus wraps/car wraps |
| | Billboards/large format |
| | Forms-templates and graphics to pull from for easy form |
| | creation |

What is claimed is:

1. A system comprising:
a template builder module to:
receive a folding parameter; and
dynamically create a template comprising a compensation value.

2. A method comprising:
calculating dimensions of a document using a folding input parameter;
calculating a compensation value using a compensation preference; and
producing a page layout template based on the dimensions of the document and the compensation value.
